(19) United States
(12) Patent Application Publication
(10) Pub. No.: US 2026/0127485 A1
(43) Pub. Date: May 7, 2026

(54) METHODS AND SYSTEMS FOR TRAINING A MACHINE LEARNING MODEL WITH GRAPH STRUCTURE INFORMATION

(71) Applicant: MASTERCARD INTERNATIONAL INCORPORATED, Purchase, NY (US)

(72) Inventors: Ushmita PAREEK, Khargone (IN); Sonia GUPTA, Gurgaon (IN); Sanjay Kumar PATNALA, Chintalapudi (IN); Krisha Ketan SHAH, Malad (IN); Siddhartha ASTHANA, New Delhi (IN)

(73) Assignee: MASTERCARD INTERNATIONAL INCORPORATED, Purchase, NY (US)

(21) Appl. No.: 18/936,527

(22) Filed: Nov. 4, 2024

(51) Int. Cl. G06N 20/00

(52) U.S. Cl. CPC G06N 20/00

(57) ABSTRACT

Methods and systems for training a Machine Learning (ML) model with graph structure information are disclosed. The method performed by a server system includes accessing for each node in a graph, node features, class label, and attention score from a database, determining difficulty metric and generating sequence of node batches for training the student ML model. Each node batch includes a subset of nodes in a predefined difficulty metric range associated with each node batch. Method includes training the student ML model based on performing, iteratively, first set of operations including: selecting node batch; generating node embeddings; determining positive embedding pairs and negative embedding pairs based on the attention score; computing, by an attention-aided contrastive loss function, losses including at least an attention-aided contrastive loss; and optimizing the student model parameters based on the losses. For a subsequent iteration, a subsequent node batch is selected from the sequence.

### TECHNICAL FIELD

The present disclosure relates to artificial intelligence-based processing systems and, more particularly, to electronic methods and complex processing systems for training a Machine Learning (ML) model such as a student ML model with graph structure information.

### BACKGROUND

With the advent of technology, Machine Learning (ML) models have evolved to analyze and interpret complex datasets structured in networks or graphs. As may be understood, graphs can capture relational information between elements and hence can be used to represent complex datasets. A wide range of applications exist that involve complex datasets that can be represented in graphs, such as molecular structures in chemistry, social and commercial connections in a social network, payment network, citation network, etc. Conventionally, several Graph Neural Networks (GNNs) have been developed to learn insights from graph-structured data. GNNs leverage node features and graph structure to learn representations that capture the relational dependencies and patterns in the data. GNNs can be used for various graph-related tasks, such as node classification, link prediction, graph classification, recommendation systems, etc. However, GNNs fail to capture the global structure of the graphs due to over-smoothing and over-squashing issues.

As a result, Graph Transformers (GTs) are developed as powerful alternatives to traditional GNNs, excelling in various graph-related tasks due to their ability to capture global information. More specifically, GTs, through their global attention mechanisms, can overcome the local structure bias of GNNs, offering State-Of-The-Art (SOTA) performance in various graph-related tasks. However, their adoption in resource-constrained environments is limited due to high inference times, primarily due to the quadratic computational complexity of the attention mechanism. On the other hand, Multilayer Perceptron (MLP)-based models and other ML models with simpler model architecture are favorable model architectures for rapid inference. However, such model architectures cannot process a graph's structural information, leading to a compromised performance in relational learning tasks. Further, despite their inability to utilize the graph's structural and relational information effectively, the MLP-based models are preferred for rapid inference. Furthermore, although model compression through pruning and quantization have been explored to accelerate transformer inference, they often involve trade-offs. For example, structured pruning can streamline the model to suit deployment constraints, yet it might not always preserve optimal accuracy, especially for complex graph structures or larger node sets. This complexity, driven by the attention mechanism's exhaustive node-to-node interactions, underscores the challenge of balancing performance and efficiency in GT deployments.

To address this problem, conventionally, several approaches have been implemented. These approaches consider the possibility of combining the benefits of both graph-based models and MLPs using knowledge distillation. As may be understood, knowledge distillation refers to the process of transferring knowledge learned by larger models (i.e., a teacher model) to a smaller model (i.e., a student model). It is noted that the conventional approaches involve knowledge distillation from GNNs or GCNs to MLPs. One such approach uses logits to distill knowledge from the teacher model to the student MLP, which cannot completely capture graph structure information. To address this problem, another approach is proposed, that extracts node position features from a graph along with node features and uses them to cover the structural information at the student MLP during inference. However, this approach is also associated with several drawbacks. One such drawback is that the student MLP requires graph structure information during inference. Another drawback lies in a technique that uses the local structural information from truncated random walks to learn latent representations. This is more suitable for message-passing GNNs which also utilize local structure information, rather than GTs that rely on attention mechanisms to capture global structure information, especially for large graphs.

Thus, there exists a need for technical solutions, such as improved methods and systems for training an ML model with graph structure information while overcoming the aforementioned technical drawbacks.

### SUMMARY

Various embodiments of the present disclosure provide methods and systems for training a Machine Learning (ML) model with graph structure information.

In an embodiment, a computer-implemented method for training a Machine Learning (ML) model with graph structure information is disclosed. The computer-implemented method performed by a server system includes accessing for each node of a set of nodes in a graph, a set of node features, a class label, and an attention score from a database associated with the server system. The class label includes one of a predefined label and a hard label prediction. The attention score indicates an importance of each node with respect to a reference node in the graph. The computer-implemented method further includes determining a difficulty metric for each node based, at least in part, on the corresponding set of node features and the corresponding class label. Furthermore, the computer-implemented method includes generating a sequence of node batches for training the student ML model based, at least in part, on the difficulty metric of each node. Each node batch includes a subset of nodes from the set of nodes in a predefined difficulty metric range associated with each node batch. The computer-implemented method further includes initializing the student ML model based, at least in part, on one or more student model parameters. Moreover, the computer-implemented method includes training the student ML model based, at least in part, on performing a first set of operations iteratively until a predefined criterion is met. The first set of operations includes: (i) selecting a node batch from the sequence of node batches; (ii) generating, by the student ML model, a set of node embeddings for the subset of nodes based, at least in part, on the set of node features of each node in the selected node batch; (iii) determining, by the student ML model, a set of positive embedding pairs and a set of negative embedding pairs from the set of node embeddings based, at least in part, on the attention score of each node in the subset of nodes; (iv) computing one or more losses including at least an attention-aided contrastive loss, wherein the attention-aided contrastive loss is computed by an attention-aided contrastive loss function based, at least in part, on the set of positive embedding pairs and the set of negative embedding pairs; and (v) optimizing the one or more student model parameters based, at least in part, on the one or more losses. Herein, for a subsequent iteration, a subsequent node batch is selected from the sequence of node batches.

In another embodiment, a server system is disclosed. The server system includes a communication interface and a memory including executable instructions. The server system also includes a processor communicably coupled to the communication interface and the memory. The processor is configured to execute the instructions to cause the server system, at least in part, to access for each node of a set of nodes in a graph, a set of node features, a class label, and an attention score from a database associated with the server system. The class label includes one of a predefined label and a hard label prediction. The attention score indicates an importance of each node with respect to a reference node in the graph. The server system is further caused to determine a difficulty metric for each node based, at least in part, on the corresponding set of node features and the corresponding class label. Furthermore, the server system is caused to generate a sequence of node batches for training the student ML model based, at least in part, on the difficulty metric of each node. Each node batch includes a subset of nodes from the set of nodes in a predefined difficulty metric range associated with each node batch. The server system is further caused to initialize the student ML model based, at least in part, on one or more student model parameters. Moreover, the server system is caused to train the student ML model based, at least in part, on performing a first set of operations iteratively until a predefined criterion is met. The first set of operations includes: (i) selecting a node batch from the sequence of node batches; (ii) generating, by the student ML model, a set of node embeddings for the subset of nodes based, at least in part, on the set of node features of each node in the selected node batch; (iii) determining, by the student ML model, a set of positive embedding pairs and a set of negative embedding pairs from the set of node embeddings based, at least in part, on the attention score of each node in the subset of nodes; (iv) computing one or more losses including at least an attention-aided contrastive loss, wherein the attention-aided contrastive loss is computed by an attention-aided contrastive loss function based, at least in part, on the set of positive embedding pairs and the set of negative embedding pairs; and (v) optimizing the one or more student model parameters based, at least in part, on the one or more losses. Herein, for a subsequent iteration, a subsequent node batch is selected from the sequence of node batches.

In yet another embodiment, a non-transitory computer-readable storage medium is disclosed. The non-transitory computer-readable storage medium includes computer-executable instructions that, when executed by at least a processor of a server system, cause the server system to perform a method. The method includes accessing for each node of a set of nodes in a graph, a set of node features, a class label, and an attention score from a database associated with the server system. The class label includes one of a predefined label and a hard label prediction. The attention score indicates an importance of each node with respect to a reference node in the graph. The method further includes determining a difficulty metric for each node based, at least in part, on the corresponding set of node features and the corresponding class label. Furthermore, the method includes generating a sequence of node batches for training the student ML model based, at least in part, on the difficulty metric of each node. Each node batch includes a subset of nodes from the set of nodes in a predefined difficulty metric range associated with each node batch. The method further includes initializing the student ML model based, at least in part, on one or more student model parameters. Moreover, the method includes training the student ML model based, at least in part, on performing a first set of operations iteratively until a predefined criterion is met. The first set of operations includes: (i) selecting a node batch from the sequence of node batches; (ii) generating, by the student ML model, a set of node embeddings for the subset of nodes based, at least in part, on the set of node features of each node in the selected node batch; (iii) determining, by the student ML model, a set of positive embedding pairs and a set of negative embedding pairs from the set of node embeddings based, at least in part, on the attention score of each node in the subset of nodes; (iv) computing one or more losses including at least an attention-aided contrastive loss, wherein the attention-aided contrastive loss is computed by an attention-aided contrastive loss function based, at least in part, on the set of positive embedding pairs and the set of negative embedding pairs; and (v) optimizing the one or more student model parameters based, at least in part, on the one or more losses. Herein, for a subsequent iteration, a subsequent node batch is selected from the sequence of node batches.

### BRIEF DESCRIPTION OF THE FIGURES

For a more complete understanding of example embodiments of the present disclosure, reference is now made to the following descriptions taken in connection with the accompanying drawings in which:

FIG. 1 illustrates a schematic representation of an environment related to at least some example embodiments of the present disclosure;

FIG. 2 illustrates a simplified block diagram of a server system, in accordance with an embodiment of the present disclosure;

FIG. 3 illustrates a schematic representation of an architecture for training a Machine Learning (ML) model with graph structure information, in accordance with an embodiment of the present disclosure;

FIG. 4 illustrates a block diagram of a curriculum learning framework for knowledge distillation, in accordance with an embodiment of the present disclosure;

FIG. 5A illustrates a schematic representation of determining a label metric for a node in a graph, in accordance with an embodiment of the present disclosure;

FIG. 5B illustrates a schematic representation of determining a feature metric for a node in a graph, in accordance with an embodiment of the present disclosure;

FIG. 6 illustrates a graphical representation of a comparative analysis of a variation of accuracy with inference time for different ML models, in accordance with an embodiment of the present disclosure;

FIG. 7 illustrates a graphical representation of a comparative analysis of an impact of the curriculum learning framework on noisy features for different ML models, in accordance with an embodiment of the present disclosure;

FIG. 8 illustrates a schematic representation of another environment related to at least some example embodiments of the present disclosure;

FIG. 9 illustrates a schematic representation of yet another environment related to at least some example embodiments of the present disclosure; and

FIGS. 10A and 10B, collectively, illustrate a flow diagram depicting a method for training an ML model with graph structure information, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Embodiments of the present disclosure may be embodied as an apparatus, a system, a method, or a computer program product. Accordingly, embodiments of the present disclosure may take the form of an entire hardware embodiment, an entire software embodiment (including firmware, resident software, micro-code, etc.), or an embodiment combining software and hardware aspects that may all generally be referred to herein as a “circuit”, “engine”, “module”, or “system”. Furthermore, aspects of the present disclosure may take the form of a computer program product embodied in one or more computer-readable storage media having computer-readable program code embodied thereon.

For elucidatory purposes, the term “entity” refers to a distinct unit that can be identified, described, or referred to as an individual, an object, a concept, or a thing. Further, entities are often characterized by a set of properties or attributes that define their unique characteristics. Furthermore, entities in the context of a network or a graph are represented as ‘nodes’ or ‘vertices’ that can be connected to other entities through ‘edges’ or ‘links’ which represent relationships or interactions between the entities that are connected by the corresponding edges. The attributes or the features that describe them can be categorical (e.g., type of entity) or numerical (e.g., a numerical Identifier (ID) or weight). Moreover, each entity usually is assigned a unique ID or characteristic that distinguishes it from other entities in the graph or the network. For example, in social networks, entities represent individuals with edges representing relationships or interactions, such as friendships, fellow relationships, communications, or the like. Node classification can be used to classify entities such as users in groups such as ‘influencers’ or ‘regular users’ based on their connectivity and activity patterns. In transportation networks, entities represent intersections or regions and edges represent connections, such as roads, flights, or train tracks. Node classification can be used to predict traffic conditions such as congestion levels based on connectivity and traffic flow patterns. Similarly, in financial networks, entities can represent financial institutions, cardholders, merchants, issuing banks, acquiring banks, or the like whereas edges represent financial transactions or relationships between the entities that connect them. Node classification can be used to predict fraudulent entities in the payment network represented by the graph.

Further, the term “Knowledge distillation” used throughout the description refers to a process of transferring knowledge from a larger teacher Machine Learning (ML) model to a smaller student ML model by matching their probability distributions. Knowledge distillation allows the student ML model to achieve performance that is similar to the teacher ML model while being much smaller and faster. The larger teacher ML model can be any ML model that is designed to learn insights from complex datasets. On the other hand, the student ML model can be any ML model that cannot learn from complex datasets, rather it requires fewer resources and provides faster inferences compared to the teacher ML model. The concept of knowledge transfer aims to combine the benefits of both the larger teacher ML model and the smaller student ML model.

Further, the terms “cardholder”, “user”, “account holder”, “consumer”, and “buyer” are used interchangeably throughout the description and refer to a person who has a payment account or at least one payment card (e.g., credit card, debit card, etc.). The payment card may or may not be associated with the payment account and will be used by a merchant to complete the payment transaction initiated by the cardholder. The payment account may be opened via an issuing bank or an issuer server.

The term “merchant”, used throughout the description generally refers to a seller, a retailer, a purchase location, an organization, or any other entity that is in the business of selling goods or providing services. Moreover, it can refer to either a single business location or a chain of business locations of the same entity.

The term “payment account” used throughout the description refers to a financial account that is used to fund a financial transaction. Examples of the financial account include, but are not limited to, a savings account, a credit account, a checking account, and a virtual payment account.

The terms “payment transaction”, “financial transaction”, “e-commerce transaction”, “digital transaction”, and “transaction” are used interchangeably throughout the description and refer to a transaction of a payment of a certain amount being initiated by the cardholder.

The term “issuer”, used throughout the description, refers to a financial institution normally called an “issuer bank” or “issuing bank” in which an individual or an institution may have an account. The issuer also issues a payment card, such as a credit card, a debit card, etc. Further, the issuer may also facilitate online banking services, such as electronic money transfer, bill payment, etc., to the cardholders through a server which is called “issuer server” throughout the description.

The term “acquirer”, used throughout the description, refers to a financial institution (e.g., a bank) that processes financial transactions for merchants. In other words, this can be an institution that facilitates the processing of payment transactions for physical stores, merchants, or institutions that own platforms that make either online purchases or purchases made via software applications possible (e.g., the shopping cart platform providers and the in-app payment processing providers).

The terms “payment network” and “card network” are used interchangeably throughout the description and refer to a network or collection of systems used for the transfer of funds using cash substitutes. Payment networks may use a variety of different protocols and procedures to process the transfer of money for various types of transactions. Payment networks are companies that connect an issuing bank with an acquiring bank to facilitate online payment. It is noted that the payment networks are operated by organizations that are called “payment processors” throughout the description.

The terms “payment card” and “card” are used interchangeably throughout the description and refer to a physical or virtual card that may or may not be linked with a financial or payment account. It may be presented to a merchant or any such facility to fund a financial transaction via the associated payment account. Examples of payment cards include, but are not limited to, debit cards, credit cards, prepaid cards, virtual payment numbers, virtual card numbers, forex cards, charge cards, e-wallet cards, and stored-value cards.

### Overview

Various embodiments of the present disclosure provide methods, systems electronic devices, and computer program products for training a Machine Learning (ML) model with graph structure information. In one embodiment, the present disclosure describes a server system that is configured to access an entity-related dataset from a database associated with the server system. The entity-related dataset may include information related to a plurality of entities. The server system may generate a set of features corresponding to each entity of the plurality of entities based, at least in part, on the information related to the plurality of entities. Further, the server system may generate a graph based, at least in part, on the set of features for each entity. Herein, each particular node of the graph corresponds to each particular entity of the plurality of entities. Upon generating the graph, a teacher ML model associated with the server system may have to be trained. Thus, the server system can be configured to access a training graph from the database. Herein, the training graph may include a set of training nodes including a set of training labeled nodes and a set of training unlabeled nodes connected through a set of training edges. Herein, each training node in the set of training nodes is associated with a set of training node features and a training positional encoding and each training labeled node in the set of training labeled nodes is associated with a predefined label. Further, the server system may initialize the teacher ML model based, at least in part, on one or more teacher model parameters. Furthermore, the server system may train the teacher ML model based, at least in part, on performing a second set of operations, for the set of training nodes, iteratively until a teacher predefined criterion is met. In one embodiment, the second set of operations include: (i) generating, by the teacher ML model, a set of teacher node embeddings based, at least in part, on the corresponding set of training node features and a corresponding training positional encoding of each training node; (ii) determining, by the teacher ML model, a set of attention scores based, at least in part, on the set of teacher node embeddings; (iii) generating, by the teacher ML model, a teacher probability score for each training unlabeled node in the set of training unlabeled nodes based, at least in part, on the set of teacher node embeddings; (iv) generating, by the teacher ML model, a teacher node class prediction for each training unlabeled node based, at least in part, on the teacher probability score, the teacher node class prediction including the hard label prediction; (v) computing, by a cross-entropy loss function, a teacher cross-entropy loss for each training unlabeled node based, at least in part, on the teacher node class prediction and a ground truth label associated with the corresponding unlabeled node; and (vi) optimizing the one or more teacher model parameters based, at least in part, on the teacher cross-entropy loss.

In a non-limiting implementation, the server system may be configured to access the graph from the database. Herein, the graph may include the set of nodes including a set of labeled nodes, and a set of unlabeled nodes connected through a set of edges. Each node is associated with a set of node features and a positional encoding and each labeled node is associated with the predefined label. Further, the server system may determine, by the teacher ML model associated with the server system, the attention score for each node based, at least in part, on the corresponding set of node features and the corresponding positional encoding of each node. Furthermore, the server system may generate, by the teacher ML model, the hard label prediction for each unlabeled node in the set of unlabeled nodes based, at least in part, on the corresponding set of node features and the attention score.

In a specific embodiment, the server system is configured to access for each node of a set of nodes in the graph, the set of node features, a class label, and an attention score from the database. The class label may include one of the predefined label and the hard label prediction. The attention score may indicate an importance of each node with respect to a reference node in the graph. Further, the server system may determine a difficulty metric for each node based, at least in part, on the corresponding set of node features and the corresponding class label. More specifically, to determine the difficulty metric for each node, the server system may determine a label metric for each node based, at least in part, on the corresponding class label. The server system may further determine a feature metric for each node based, at least in part, on the corresponding set of node features. Furthermore, the server system may compute the difficulty metric based, at least in part, on the label metric and the feature metric.

In an embodiment, to compute the label metric for each node, the server system is configured to identify one or more neighbor nodes of each node. Further, the server system may determine a class label corresponding to each neighbor node of the one or more neighbor nodes. The server system may further compute the label metric based, at least in part, on the corresponding class label of each node and the class label corresponding to each neighbor node.

In another embodiment, to compute the feature metric for each node, the server system is configured to segregate a first subset of nodes associated with a first class label and a second subset of nodes associated with a second class label from the set of nodes based, at least in part, on the class label associated with each node. The server system may further extract from the teacher ML model, a first subset of teacher node embeddings for the corresponding first subset of nodes and a second subset of teacher node embeddings for the corresponding second subset of nodes based, at least in part, on a set of teacher node embeddings of the set of nodes. Further, the server system may generate a first class representation representing a first class of the first subset of nodes based, at least in part, on an aggregation of the first subset of teacher node embeddings. Furthermore, the server system may generate a second class representation representing a second class of the second subset of nodes based, at least in part, on aggregation of the second subset of teacher node embeddings. Moreover, the server system may compute the feature metric based, at least in part, on comparing the first class representation, the second class representation, and a teacher node embedding corresponding to each node.

In another specific embodiment, the server system may generate a sequence of node batches for training the student ML model based, at least in part, on the difficulty metric of each node. Each node batch may include a subset of nodes from the set of nodes in a predefined difficulty metric range associated with each node batch. The server system may initialize the student ML model based, at least in part, on one or more student model parameters. Further, the server system may train the student ML model to obtain a trained student ML model based, at least in part, on performing a first set of operations iteratively until a predefined criterion is met. The first set of operations may include: (i) selecting, by the server system, a node batch from the sequence of node batches (ii) generating, by the student ML model, a set of node embeddings for the subset of nodes based, at least in part, on the set of node features of each node in the selected node batch; (iii) determining, by the student ML model, a set of positive embedding pairs and a set of negative embedding pairs from the set of node embeddings based, at least in part, on the attention score of each node in the subset of nodes; (iv) computing one or more losses including at least an attention-aided contrastive loss, wherein the attention-aided contrastive loss is computed by an attention-aided contrastive loss function based, at least in part, on the set of positive embedding pairs and the set of negative embedding pairs; and (v) optimizing the one or more student model parameters based, at least in part, on the one or more losses. Herein, for a subsequent iteration, a subsequent node batch is selected from the sequence of node batches.

In a non-limiting example, to determine the set of positive embedding pairs, the server system may be configured to randomly select at least one node from the node batch as the reference node. Further, the server system may access the set of node features associated with the reference node from the database. Furthermore, the server system may generate a reference node embedding for the reference node based, at least in part, on the set of reference node features. Moreover, the server system may identify a first subset of node embeddings from the set of node embeddings that are related to the reference node embedding based, at least in part, on the class label of each node in the node batch to obtain the set of positive embedding pairs.

In another non-limiting example, to determine the set of negative embedding pairs, the server system may be configured to identify a second subset of node embeddings from the set of node embeddings that are unrelated to the reference node embedding based, at least in part, on the class label of each node in the node batch to obtain the set of negative embedding pairs.

In some embodiments, to compute the one or more losses such as at least a cross-entropy loss, the server system is configured to generate, by the student ML model, a set of probability scores for the subset of nodes based, at least in part, on the corresponding set of node embeddings. The server system may generate, by the student ML model, a node class prediction for each node in the subset of nodes based, at least in part, on the set of probability scores. The node class prediction may include a student-hard label prediction. Further, the server system may compute, by a cross-entropy loss function, the cross-entropy loss for each node based, at least in part, on the node class prediction and a ground truth label associated with the corresponding node.

In some other embodiments, to compute the one or more losses such as at least a Kullback-Leibler (KL) divergence loss, the server system is configured to generate, by the student ML model, a probability score for each node in the subset of nodes based, at least in part, on the corresponding set of node embeddings. Further, the server system may extract, from the teacher ML model, a teacher probability score associated with the hard label prediction. Furthermore, the server system may compute, by a KL divergence loss function, the KL divergence loss for each node based, at least in part, on the probability score and the teacher probability score of the corresponding node.

In a specific embodiment, the server system is configured to receive a prediction request related to the downstream task for an entity associated with an individual node from the set of nodes. The server system is further configured to generate, by the trained student ML model associated with the server system, a task-specific prediction corresponding to the downstream task for the individual node based, at least in part, on a corresponding plurality of node features of the individual node.

Various embodiments of the present disclosure offer multiple advantages and technical effects. For instance, the present disclosure aims to solve the technical problem of enabling graph structure-independent inference. More specifically, it solves the problem of effectively transferring local structure knowledge and global structure knowledge from the teacher model, i.e., the teacher GT model to the student model, i.e., the student MLP model which can achieve significantly faster inference while maintaining comparable accuracy to the GT. The structure-aware MLP leverages the attention scores obtained through an Attention-aided contrastive loss for Graphs (AACLG) that enables the MLP to prioritize node relationships similarly to the GT. This equips the MLP with the capacity to discern and represent both proximal and distant node interactions effectively without requiring graph structure information during inference.

Further, the usage of curriculum learning for knowledge distillation can lead to better generalization performance of the student MLP model on unseen data. It also stabilizes the training process by improving the convergence of the student MLP model. Additionally, it can act as a form of regularization by encouraging the student MLP model to learn simpler concepts first, thereby preventing over-fitting to more complex or noisy features. As a result, the proposed approach can handle noisy features better than conventional approaches.

For example, in the transportation and logistics industry, a graph can be used to represent a traffic network. Nodes in the graph can represent intersections or regions. Further, node classification can be used to predict traffic conditions such as congestion levels based on connectivity and traffic flow patterns. To perform node classification, an AI or ML model that is capable of processing graphs may have to be trained, such as GTs. Since models that can process graphs such as the GTs cannot be used in resource-constrained environments due to high inference times, a smaller model such as an MLP can be used. Herein, the MLP is considered as a student ML model which will receive learning or knowledge from a teacher ML model such as the GT through a knowledge distillation process. The node features such as the connectivity and traffic flow patterns of a traffic network along with an attention score of each node in the traffic network are transferred to the student ML model. Later, the student ML model is trained using the concept of curriculum learning to provide better generalization performance of the student MLP model on unseen data. Upon training the student ML model, it can be used to predict real-time traffic conditions of any location without requiring access to the structure of the traffic network.

In another example of the payment industry, the historical transaction data can be represented in the form of a graph. Nodes in the graph can represent entities, such as cardholders, merchants, acquirers, issuers, etc., among other members in a payment network. Edges represent the payment transactions performed between the entities. It is noted that each node and each edge can be associated with individual features. Further, node classification can be used for fraud detection based on transaction patterns between the entities represented by the graph. As may be understood, AI or ML models that can process graph structure data, such as the GNNs, GTs, etc., among other models have high inference times. Thus, it cannot be used in resource-constrained environments, however, smaller models such as MLP can be used. To receive the performance benefits of the graph-based models and the faster inference time benefits of the MLP, knowledge distillation from a teacher ML model such as the GT to a student ML model such as the MLP is performed in the approach proposed in the present disclosure. The node features such as transaction-related features (e.g., transaction amount, transaction frequency, payment mode, etc.) associated with each cardholder in the payment network along with attention score are transferred to the student ML model. Later, the student ML model is trained with this information by employing the concept of curriculum learning to provide better generalization performance of the student ML model on unseen data. Upon training the student ML model, it can be used to perform real-time fraud detection of any cardholder without requiring access to the structure of the payment network represented as a graph.

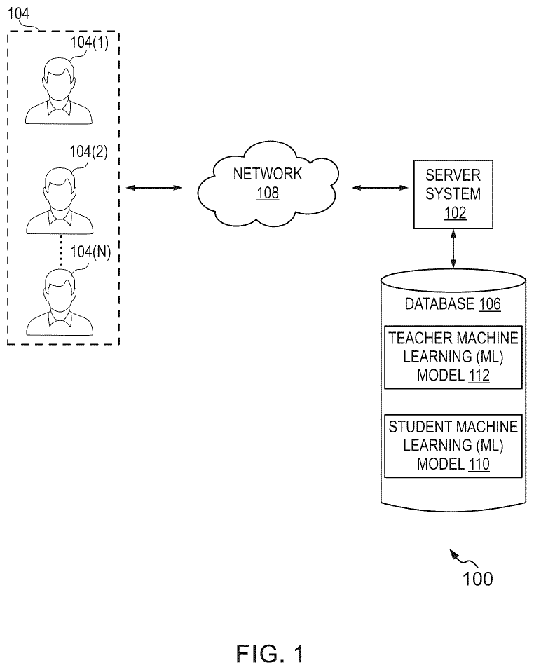

Various example embodiments of the present disclosure are described hereinafter with reference to FIG. 1 to FIGS. 10A and 10B.

FIG. 1 illustrates a schematic representation of an environment 100 related to at least some example embodiments of the present disclosure. Although the environment 100 is presented in one arrangement, other embodiments may include the parts of the environment 100 (or other parts) arranged otherwise depending on, for example, training a Machine Learning (ML) model such as a student ML model, and the like.

The environment 100, generally includes a plurality of parties, such as a server system 102, a plurality of entities 104(1), 104(2), . . . 104(N) (collectively referred to hereinafter as the ‘plurality of entities 104’ or simply, ‘entities 104’), a database 106, each coupled to, and in communication with (and/or with access to) a network 108. Herein, ‘N’ is a non-zero natural number.

It is noted that various entities such as the entities 104 interact with each other in the network 108 and hence, the relations between the entities 104 can be represented in the form of a graph. As may be understood, the graph includes a plurality of nodes and a plurality of edges with each edge of the plurality of edges connecting two distinct nodes. The nodes represent the individual entities, and the edges represent the relation between two entities connected by the particular edge. Each node can be associated with a plurality of node features and each edge can be associated with a plurality of edge features. For instance, in the payment industry, the entities can be cardholders, merchants, issuer servers, acquirer servers, and the like in a payment network.

The graph can be a homogeneous graph or a heterogenous graph. Homogeneous graphs include nodes of the same type and edges also represent the same type of relationship. Various examples of homogeneous graphs include a social network graph, a citation graph, cardholder network, etc. Similarly, the heterogeneous graph includes nodes of different types, and edges can represent different types of relationships. Various examples of heterogenous graphs include a knowledge graph, a bipartite graph, a multi-partite graph, etc.

As explained earlier, while most Graph Neural Networks (GNNs) effectively capture the local structure of the graph neighboring to a node in the graph, they often fail to capture the global structure of the graph. To address this, Graph Transformers (GTs) have emerged as powerful models for various graph-related tasks, primarily due to their ability to capture a node's position in the broader context of graph structure along with its local structural information. In an implementation, the structure information related to the graphs is achieved through attention mechanisms and positional encoding techniques. Examples of positional encoding techniques can include Weis Feiler Lehman-based absolute Positional Encoding (WL-PE) and Laplacian PE. The high performance of the GTs, however, comes with the disadvantage of high inference times and hence impose limitations on deployment.

To address the above-mentioned technical problems, knowledge distillation has been developed for graph machine learning, through which knowledge of the larger teacher models such as graph-based models can be transferred to smaller student models such as a Multilayer Perceptron (MLP). As a result, both competitive performance and faster inference can be achieved. Some of the State-Of-The-Art (SOTA) conventional approaches that have developed knowledge distillation frameworks include Graph-less Neural Networks (GLNN) and Noise-robust Structure-aware MLPs on Graphs (NOSMOG). However, these conventional approaches distill knowledge from GNNs to MLPs, failing to capture the global structure of the graph which in turn can negatively affect the accuracy of the predictions related to any downstream task. Also, GLNN utilizes only logits for training the MLP, discarding structure information available in graph data and hence resulting in an MLP that is not structure-aware. Further, NOSMOG overcomes this limitation by passing a node feature concatenated with its positional encoding as an input to the student MLP. It is noted that NOSMOG requires the availability of graph structure information during inference to compute the positional encoding. The positional encodings are extracted using an approach that uses local structural information from truncated random walks which is more suitable for message-passing GNNs. However, both these frameworks are not suitable for GT architectures which use attention mechanisms and positional encoding techniques to capture the rich local and global structural context present in graph data.

Therefore, the above-mentioned technical problems, among other problems, are addressed by one or more embodiments implemented by the server system 102 and the methods thereof provided in the present disclosure. It should be noted that the server system 102 is configured to train an ML model such as a student ML model (e.g., the student ML model 110) with graph structure information. Upon doing so, the student ML model 110 can be used to provide inference to a downstream task without requiring access to the graph or any graph structure information.

In one embodiment, the server system 102 may be used by a managing entity (not shown) to train an ML model such as a student ML model (hereinafter, also referred to a ‘student model’) (e.g., the student ML model 110) with the graph structure information learned by another ML model such as a teacher ML model (hereinafter, also referred to a ‘teacher model’) (e.g., the teacher ML model 112) using knowledge distillation. The student ML model 110 may be trained to perform a downstream task based on the insights obtained from the graph structure information. Examples of the downstream task includes node classification, link prediction, graph classification, recommendation systems, etc., among other downstream tasks.

In a non-limiting implementation, the managing entity may be any individual, representative of a person, an institution, an organization, a corporate entity, a non-profit organization, a financial institution, a bank, medical facilities (e.g., hospitals, laboratories, etc.), educational institutions, government agencies, telecom industries, or the like. In an example, the managing entity may be an administrator of the server system 102.

In one embodiment, the entities 104 may include individuals, objects, or concepts that may or may not interact with each other or are related or unrelated to each other in a social network. For example, the entity (e.g., the entity 104(1)) may include any individual, representative of a person, an object, a place or a location, an institution, an organization, a corporate entity, a non-profit organization, a financial institution, a bank, a cardholder, a merchant, medical facilities (e.g., hospitals, laboratories, etc.), educational institutions, government agencies, telecom industries, or the like.

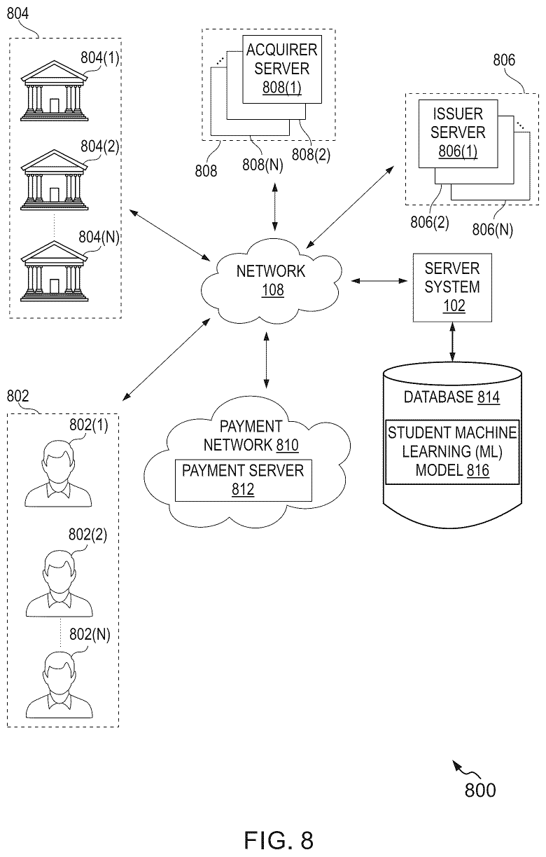

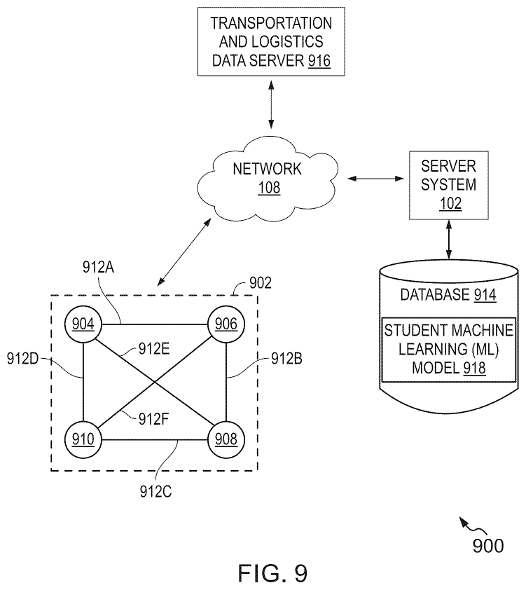

In another embodiment, the entities (e.g., the entities 104) may correspond to individuals whose data is used for training the teacher ML model 112 and the student ML model 110. The data associated with the entities 104 can be referred to as an ‘entity-related dataset’ which may be stored in the database 106. For instance, within a payment industry (as described with reference to FIG. 8), the entities 104 can be cardholders, merchants, consumers, issuers, acquirers, banks, third-party users, financial institutions, or the like. Data related to such individuals include historical financial transaction-related data, income-related data, expenditure-related data, and the like. The data represented in the graph form can be used to train the teacher ML model 112 for performing a downstream task such as fraud detection. However, during the inference or deployment stage, the learnings from the teacher ML model 112 are transferred to the student ML model 110 using the approach proposed in the present disclosure. Then, the student ML model 110 can be used to generate faster inferences about the fraud detection task without requiring the generation of a graph or access to a graph used by the teacher ML model 112. In another instance, within a transportation and logistics industry, the entities 104 can be an intersection of roads or regions (as described with reference to FIG. 9). Data related to such entities can be represented in the graph form and used by the teacher ML model 112 to learn and understand the traffic conditions of different locations. Then, using the approach proposed in the present disclosure, the learnings of the teacher ML model 112 are transferred to the student ML model 110. Thus, the student ML model 110 can be used during the inference stage to get faster inferences about the traffic conditions at a particular region or the intersection of the roads.

In some embodiments, the entities 104 may use their corresponding electronic devices (not shown in figures) to access a mobile application or a website associated with a third-party application to facilitate the entities 104 to perform an event. In various non-limiting examples, the electronic devices may refer to any electronic devices, such as, but not limited to, Personal Computers (PCs), tablet devices, smart wearable devices, Personal Digital Assistants (PDAs), voice-activated assistants, Virtual Reality (VR) devices, smartphones, laptops, and the like.

In various embodiments, the network 108 may include, without limitation, a Light Fidelity (Li-Fi) network, a Local Area Network (LAN), a Wide Area Network (WAN), a Metropolitan Area Network (MAN), a satellite network, the Internet, a fiber optic network, a coaxial cable network, an infrared (IR) network, a Radio Frequency (RF) network, a virtual network, and/or another suitable public and/or private network capable of supporting communication among two or more of the parts or users illustrated in FIG. 1, or any combination thereof.

Various entities in the environment 100 may connect to the network 108 in accordance with various wired and wireless communication protocols, such as Transmission Control Protocol and Internet Protocol (TCP/IP), User Datagram Protocol (UDP), 2^{nd} Generation (2G), 3^{rd} Generation (3G), 4th Generation (4G), 5th Generation (5G) communication protocols, Long Term Evolution (LTE) communication protocols, New Radio (NR) communication protocol, any future communication protocol, or any combination thereof. In some instances, the network 108 may utilize a secure protocol (e.g., Hypertext Transfer Protocol (HTTP), Secure Socket Lock (SSL), and/or any other protocol, or set of protocols for communicating with the various entities depicted in FIG. 1.

In a specific embodiment, along with the entity-related dataset corresponding to the entities 104, the server system 102 can also store one or more AI or ML models, such as the teacher ML model 112 and the student ML model 110 in the database 106. The database 106 can also store other necessary machine instructions required for implementing the various functionalities of the server system 102 such as firmware data, operating system, and the like. In a particular non-limiting instance, the server system 102 may locally store the student ML model 110 as well (as depicted in FIG. 1). In one embodiment, the database 106 may be incorporated in the server system 102 or maybe an individual entity connected to the server system 102 or maybe a database stored in cloud storage. In various non-limiting examples, the database 106 may include one or more Hard Disk Drives (HDD), Solid-State Drives (SSD), an Advanced Technology Attachment (ATA) adapter, a Serial ATA (SATA) adapter, a Small Computer System Interface (SCSI) adapter, a Redundant Array of Independent Disks (RAID) controller, a Storage Area Network (SAN) adapter, a network adapter, and/or any component providing the server system 102 with access to the database 106. In one implementation, the database 106 may be viewed, accessed, amended, updated, and/or deleted by an administrator (not shown) associated with the server system 102 through a Database Management System (DBMS) or Relational Database Management System (RDBMS) present within the database 106.

In an example, the entity-related dataset stored in the database 106 includes information related to the plurality of entities 104, and a relationship between each of the plurality of entities 104. For instance, in the financial domain, the entity-related dataset may be a historical transaction dataset.

In another example, the student ML model 110 may be an AI or an ML based model that can be configured or trained to perform the downstream task. In a non-limiting example, the student ML model 110 is a classifier-based ML model (or a differential classifier model). Various examples of classifier-based ML models include MLPs, Convolutional Neural networks (CNNs), Recurrent Neural networks (RNNs), Long-Short Term Memory (LSTM) networks, and so on. In addition, the database 106 provides a storage location for data and/or metadata obtained from various operations performed by the server system 102. In yet another example, the teacher ML model 112 can be any graph-based model, such as a GNN, GCN, GT, or the like. In the present disclosure, the teacher ML model 112 is considered to be a GT model.

As mentioned earlier, the graph captures the relational information associated with the entities 104. In an implementation, a sparse graph structure can be considered for training the teacher ML model 112 to perform the downstream task. Further, for training the student ML model 110, in a specific embodiment, the server system 102 is configured to access for each node of a set of nodes in the graph, a set of node features, a class label, and an attention score from the database 106. Herein, the set of nodes can correspond to a subset of the plurality of nodes of the graph. For instance, the set of nodes can correspond to the sparse graph structure of the graph which is sufficient to capture graph structure information from the graph. For example, if the node represents a cardholder, the node features can correspond to a transaction amount, a cardholder Identifier (ID), a recipient ID of the transaction such as a merchant ID, a transaction time stamp, and the like corresponding to a transaction performed by the cardholder. Moreover, the term ‘set’ refers to a collection of well-defined, unordered objects called elements or members. For example, the phrases a ‘set of entities’, and a ‘set of nodes’ refer to collection of nodes and entities, respectively.

Further, it is noted that the set of nodes initially, can include a set of labeled nodes and a set of unlabeled nodes. Each labeled node in the set of labeled nodes can be associated with a label that is pre-assigned or predefined. Further, the set of unlabeled nodes may have to be labeled. Thus, in one embodiment, the server system 102 may utilize a pre-trained teacher ML model 112 (otherwise, interchangeably referred to as the ‘teacher ML model 112’) to predict such labels for the set of unlabeled nodes. Thus, the class label associated with each node may include one of a predefined label and a hard label prediction (i.e., a label predicted by the teacher ML model 112). Herein, the term ‘hard label’ refers to a final predicted label (e.g., labels ‘0’ and ‘1’ in binary classification task) that assigns a single definitive class to each data point in a dataset or each node in a graph. Furthermore, the attention score may indicate an importance of each node with respect to a reference node in the graph.

In another embodiment, the server system 102 is configured to determine a difficulty metric for each node based, at least in part, on the corresponding set of node features and the corresponding class label. Herein, the term ‘difficulty metric’ refers to a difficulty that may be faced by an ML model to learn a representation of a particular entity or a node. The process of determining the difficulty metric is explained later in the present disclosure.

In yet another embodiment, the server system 102 is configured to generate a sequence of node batches for training the student ML model 110 based, at least in part, on the difficulty metric of each node. Each node batch may include a subset of nodes from the set of nodes in a predefined difficulty metric range associated with each node batch. Further, the server system 102 may initialize the student ML model 110 based, at least in part, on one or more student model parameters. Upon initialization, the server system 102 may train the student ML model 110 to obtain a trained student ML model (not shown in FIG. 1) based, at least in part, on performing a first set of operations iteratively until a predefined criterion is met. The first set of operations may include:
(i) selecting a node batch from the sequence of node batches;
(ii) generating, by the student ML model 110, a set of node embeddings for the subset of nodes based, at least in part, on the set of node features of each node in the selected node batch;
(iii) determining, by the student ML model 110, a set of positive embedding pairs and a set of negative embedding pairs from the set of node embeddings based, at least in part, on the attention score of each node in the subset of nodes;
(iv) computing one or more losses including at least an attention-aided contrastive loss. Herein, the attention-aided contrastive loss can be computed by an attention-aided contrastive loss function based, at least in part, on the set of positive embedding pairs and the set of negative embedding pairs; and
(v) optimizing the one or more student model parameters based, at least in part, on the one or more losses.

It is noted that, for a subsequent iteration, a subsequent node batch is selected from the sequence of node batches. As may be understood, each node batch can include the subset of nodes in the predefined difficulty metric range associated with each node batch. Herein, the node batch for every iteration is different from that of each other, as the predefined difficulty metric range can be different for each node batch. Thus, the subsequent node batch is selected from the sequence for the subsequent iteration. Moreover, the process of training the student ML model 110 is explained in detail, later in the present disclosure. Upon training the student ML model 110, the trained student ML model, thus obtained can be used to generate inferences related to a downstream task without requiring access to information related to graph structure. Also, it is noted that the trained student ML model can provide faster structure-independent inference while maintaining comparable accuracy to graph-based models such as the GT.

It should be understood that the server system 102 is a separate part of the environment 100 and may operate apart from (but still in communication with, for example, via the network 108) any third-party external servers (to access data such as the training datasets to perform the various operations described herein). However, in other embodiments, the server system 102 may be incorporated, in whole or in part, into one or more parts of the environment 100.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices are shown in FIG. 1 may be implemented within a single system or device, or a single system or device is shown in FIG. 1 may be implemented as multiple, distributed systems or devices. In addition, the server system 102 should be understood to be embodied in at least one computing device in communication with the network 108, which may be specifically configured, via executable instructions, to perform steps as described herein, and/or embodied in at least one non-transitory computer-readable media.

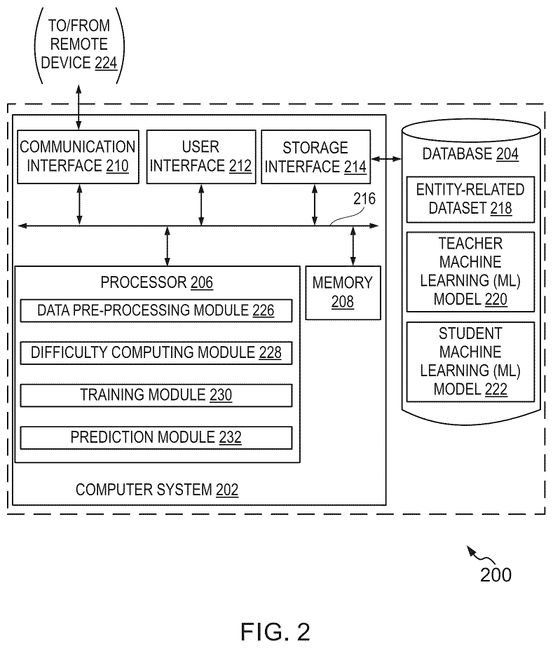

FIG. 2 illustrates a simplified block diagram of a server system 200, in accordance with an embodiment of the present disclosure. The server system 200 is identical to the server system 102 of FIG. 1. In some embodiments, the server system 200 is embodied as a cloud-based and/or software as a service (SaaS) based architecture.

The server system 200 includes a computer system 202 and a database 204. The computer system 202 includes at least one processor 206 (herein, referred to interchangeably as ‘processor 206’) for executing instructions, a memory 208, a communication interface 210, a user interface 212, and a storage interface 214. One or more components of the computer system 202 communicate with each other via a bus 216. The components of the server system 200 provided herein may not be exhaustive and the server system 200 may include more or fewer components than those depicted in FIG. 2. Further, two or more components depicted in FIG. 2 may be embodied in one single component, and/or one component may be configured using multiple sub-components to achieve the desired functionalities.

In some embodiments, the database 204 is integrated into the computer system 202. In one embodiment, the database 204 is substantially similar to the database 106 of FIG. 1. In one non-limiting example, the database 204 is configured to store an entity-related dataset 218, a teacher ML model 220, a student ML model 222, and the like. Herein, the student ML model 222 is similar to the student ML model 110 described in FIG. 1. Also, the entity-related dataset 218 and the teacher ML model 220 are also similar to the entity-related dataset and the teacher ML model described with reference to FIG. 1.

Further, the computer system 202 may include one or more hard disk drives as the database 204. The user interface 212 is an interface, such as a Human Machine Interface (HMI) or a software application that allows users 104 such as an administrator to interact with and control the server system 200 or one or more parameters associated with the server system 200. It may be noted that the user interface 212 may be composed of several components that vary based on the complexity and purpose of the application. Examples of components of the user interface 212 may include visual elements, controls, navigation, feedback and alerts, user input and interaction, responsive design, user assistance and help, accessibility features, and the like. More specifically these components may correspond to icons, layout, color schemes, buttons, sliders, dropdown menus, tabs, links, error/success messages, mouse and touch interactions, keyboard shortcuts, tooltips, screen readers, and the like.

The storage interface 214 is any component capable of providing the processor 206 access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204.

The processor 206 includes suitable logic, circuitry, and/or interfaces to execute operations for accessing a set of node features, a class label, and an attention score associated with each node in a graph, determining difficulty metric for the corresponding node, generating a sequence of node batches, training the student ML model 222, and the like. Examples of the processor 206 include, but are not limited to, an Application-Specific Integrated Circuit (ASIC) processor, a Reduced Instruction Set Computing (RISC) processor, a Graphical Processing Unit (GPU), a Complex Instruction Set Computing (CISC) processor, a Field-Programmable Gate Array (FPGA), and the like.

The memory 208 includes suitable logic, circuitry, and/or interfaces to store a set of computer-readable instructions for performing operations. Examples of the memory 208 include a Random-Access Memory (RAM), a Read-Only Memory (ROM), a removable storage drive, a Hard Disk Drive (HDD), and the like. It will be apparent to a person skilled in the art that the scope of the disclosure is not limited to realizing the memory 208 in the server system 200, as described herein. In another embodiment, the memory 208 may be realized in the form of a database server or a cloud storage working in conjunction with the server system 200, without departing from the scope of the present disclosure.

The processor 206 is operatively coupled to the communication interface 210, such that the processor 206 is capable of communicating with a remote device 224, such as electronic devices of the users 104, or communicating with any entity connected to the network 108 (as shown in FIG. 1).

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

In one implementation, the processor 206 includes a data pre-processing module 226, a difficulty computing module 228, a training module 230, and a prediction module 232. It should be noted that components, described herein, such as the data pre-processing module 226, the difficulty computing module 228, the training module 230, and the prediction module 232 can be configured in a variety of ways, including electronic circuitries, digital arithmetic, and logic blocks, and memory systems in combination with software, firmware, and embedded technologies. Moreover, it may be noted that the data pre-processing module 226, the difficulty computing module 228, the training module 230, and the prediction module 232 may be communicably coupled with each other to exchange information with each other for performing the one or more operations facilitated by the server system 200.

In one embodiment, the data pre-processing module 226 includes suitable logic and/or interfaces for accessing the entity-related dataset 218 from the database 204. The entity-related dataset 218 may include information related to a plurality of entities such as the entities 104. In a non-limiting example, the entity-related dataset 218 can also include information related to a relationship between the entities 104. The relationship between the entities 104 can be defined based on the type of interaction performed between the entities 104. Moreover, the information can be historical information or information that is captured in real-time. For instance, the information can include an interaction type, a number of interactions, entity identity-related information, a count of entities involved in an interaction, and the like corresponding to the plurality of interactions performed between the entities 104. More specifically, various examples of the information in the transportation and logistics industry can include route information, time information, traffic information, weather information, vehicle information, external events, and the like. Similarly, in an example of the financial industry, the various examples of the information can include payment transaction history, cardholder demographics, credit score, fraudulent transactions, transaction patterns, anomalies, compliance data, and the like. In various other non-limiting examples, the entity-related dataset 218 can include different information specific to any field of operation, such as the payment industry, the medical industry, the transportation and logistics industry, and the like. Therefore, it is understood that the various embodiments of the present disclosure apply to a variety of different fields of operation and the same is covered within the scope of the present disclosure.

In another embodiment, the data pre-processing module 226 is configured to generate a set of features corresponding to each entity of the entities 104 based, at least in part, on the information related to the entities 104. In various non-limiting examples, the data pre-processing module 226 can utilize any feature generation approach (otherwise also referred to as ‘featurization approach’) to generate the set of features. In one embodiment, the set of features may be extracted from the entity-related dataset 218 for each entity. In another embodiment, new features may be generated for each entity using the various data fields associated with each entity in the raw data. Both the extracted features and the newly generated features may correspond to insights, useful information, relevant patterns, and the like associated with the entity-related dataset 218. In various non-limiting examples, various featurization approaches can include removing noise, feature engineering, feature selection, data cleaning, handling missing values, normalizing or scaling data, analyzing characteristics of the data, and converting the entity-related dataset 218 into a format that any AI or ML models can process. Since such featurization approaches are well known to the person skilled in the art, the same are explained herein for the sake of brevity.

In yet another embodiment, the data pre-processing module 226 is configured to generate the graph based, at least in part, on the set of features for each entity. Herein, each particular node of the graph may correspond to each particular entity of the entities 104. As may be understood, the graph includes the set of nodes and a set of edges. Herein, each edge connects two distinct nodes. Each node indicates an individual entity, and each edge indicates the relationship between the two nodes connected by the corresponding edge. Further, each node is also associated with a set of node features, and each edge is associated with information indicating the relationship between the distinct connected by the corresponding edge. Herein, it is noted that the set of node features associated with a particular node is similar to the set of features associated with a particular entity represented by the particular node. Moreover, the set of nodes can include both the set of labeled nodes and the set of unlabeled nodes. Each labeled node is associated with a predefined label and the unlabeled node may be labeled using an AI or ML model such as the student ML model 222.

Upon obtaining the graph, the teacher ML model 220 may have to be trained to perform the downstream task such as a node classification task, so that its learning or knowledge can be distilled to the student ML model 222. Then, the student ML model 222 can be used to label the unlabeled nodes in the graph at a faster pace. To label the unlabeled nodes, a training graph may be obtained from the graph by splitting the said graph for different time stamps associated with each node in the graph. The training graph may be provided to the training module 230 to train the teacher ML model 220.

In embodiment, the training module 230 includes suitable logic and/or interfaces for accessing the training graph from the database 204. As may be understood, the training graph may include a set of training nodes including a set of training labeled nodes, and a set of training unlabeled nodes connected through a set of training edges. Each training node in the set of training nodes may be associated with a set of training node features and a training positional encoding. Similarly, each training labeled node in the set of training labeled nodes may be associated with a predefined label.

In another embodiment, the training module 230 is configured to initialize the teacher ML model 220 based, at least in part, on one or more teacher model parameters. In various non-limiting examples, the teacher model parameters may define the various aspects related to the various neural network layers of the teacher ML model 220 such as a set of shared layers and a set of classification layers of the teacher ML model 220, i.e., a number of layers, a number of hidden dimensions, learning rate, weights of different layers, weight decay, normalization factor, fan out, and the like.

Upon initialization, the training module 230 may be configured to train the teacher ML model 220 based, at least in part, on iteratively performing a second set of operations until the teacher predefined criterion is met for the set of training nodes. In a non-limiting implementation, the second set of operations may include: (i) generating, by the teacher ML model 220, a set of teacher node embeddings based, at least in part, on the corresponding set of training node features and a corresponding training positional encoding of each training node; (ii) determining, by the teacher ML model 220, a set of attention scores based, at least in part, on the set of teacher node embeddings; (iii) generating, by the teacher ML model 220, a teacher probability score for each training unlabeled node in the set of training labeled nodes based, at least in part, on the set of teacher node embeddings; (iv) generating, by the teacher ML model 220, a teacher prediction for each training unlabeled node based, at least in part, on the teacher probability score, the teacher prediction including the hard label prediction; (v) computing, by a cross-entropy loss function, a teacher cross-entropy loss for each training unlabeled node based, at least in part, on the teacher prediction and a ground truth label associated with the corresponding unlabeled node; and (vi) optimizing the one or more teacher model parameters based, at least in part, on the teacher cross-entropy loss.

The term “embeddings”, “vector representations”, and “feature representations” may be used interchangeably throughout the description and refer to a form of data that is obtained upon transformation or mapping of high-dimensional data into a lower-dimensional space. Herein, the data in the lower-dimensional space retains meaningful properties, relationships, or structure from the original data. As may be understood, the embeddings are used in ML, data science, and AI to represent complex data in a way that is computationally efficient and semantically meaningful. In addition to dimensionality reduction, other advantages of generating embeddings may include improved feature extraction and learning, improved model performance, enabling complex tasks, and the like.

As may be understood, for generating the embeddings, along with the training node features, the training positional encoding associated with each training node is also considered. It is noted that, generally, a positional encoding is determined to capture a relative position of the nodes in the graph, since unlike sequences in a Natural Language Processing (NLP), graphs don't have a natural order. In various non-limiting examples, the positional encoding is determined using various techniques, such as Laplacian eigenvectors, a random walk approach, or the like. Moreover, the process of determining the positional encoding to well known to a person skilled in the art. To that end, the process is not repeated herein for the sake of brevity.

Further, the attention score indicates the importance of each training node with respect to a training reference node in the training graph. For instance, any node in the graph can be considered as a reference node and more than one node in the graph can be referred to as the reference node. More specifically, when a node is assigned with an attention score, then that score may indicate how important the node features of said node are to another node that is connected or not connected to said node while generating a representation for the another node. Herein, the another node can be the reference node. The computation of the attention score facilitates the capturing of the global structure of the graph along with capturing the local structure. Generally, an attention matrix may be computed for the set of nodes in the graph capturing the global structure of the set of nodes in the graph.

Furthermore, the prediction may be generated for the downstream task by generating probability scores for the set of training nodes to obtain the hard label prediction for each training node. More specifically, in a node classification task, the hard label prediction segregates the nodes into at least two classes such as a first class and a second class. For example, for fraud detection, the hard label prediction can classify the set of nodes in the graph into a fraudulent class and a non-fraudulent class. Moreover, the prediction may be compared to the ground truth label associated with each training unlabeled node in the training graph, and a loss such as the cross-entropy loss is computed using a loss function such as the cross-entropy loss function. The loss is then used to optimize the teacher model parameters. In a non-limiting example, the teacher model parameters can be optimized based on the backpropagation of the cross-entropy loss. Herein, the cross-entropy loss function is well-known to a person skilled in the art. To that end, the same is not elaborated herein for the sake of brevity.

Further, the second set of operations may be performed iteratively until the teacher predefined criterion is met. In one embodiment, the teacher predefined criterion can correspond to a convergence of the teacher ML model 220. In a non-limiting example, the convergence of the teacher ML model 220 can correspond to a saturation of the teacher cross-entropy loss. The teacher cross-entropy loss can be saturated after a plurality of iterations of the second set of operations is performed. Herein, the saturation may refer to a stage in the model training process after a certain number of iterations where a loss value such as the cross-entropy loss becomes constant, i.e., the difference in the loss for one iteration and its subsequent iteration becomes the same or negligible. The loss of any model is associated with model performance, so, the less the loss the better the model performance. Hence, certain parameters associated with the model may be modified to reduce the loss value, thereby improving the model performance.

Upon training the teacher ML model 220, the hard label predictions may be obtained for the set of nodes in the graph along with the attention score for each node in the set of nodes. Thus, the teacher ML model 220 that is trained may be provided to the prediction module 232. In one embodiment, the prediction module 232 includes suitable logic and/or interfaces for accessing the graph from the database 204. Herein, the graph includes the set of nodes including a set of labeled nodes and a set of unlabeled nodes connected through a set of edges. Further, each node can be associated with the set of node features and a positional encoding, and each labeled node is associated with the predefined label.

In another embodiment, the prediction module 232 is configured to determine the attention score for each node based, at least in part, on the corresponding set of node features and the corresponding positional encoding of each node. In a non-limiting implementation, the prediction module 232 may determine the attention score using the teacher ML model 220. Upon completion of the training of the teacher ML model 220. As may be understood, the attention score can refer to the importance of each node with respect to a reference node in the graph. For instance, when the teacher ML model 220 is the Graph Transformer (GT)-based model or any attention-based model, the term ‘importance’ refers to the relevance or significance of one node's information when updating the representation of another node in the graph. More specifically, the ‘importance’ in relation to attention score can refer to how much weight or influence a neighboring node's features (e.g., its attributes or embeddings) should have on a target node during the message-passing or aggregation step.

In yet another embodiment, the prediction module 232 can generate the hard label prediction for each unlabeled node in the set of unlabeled nodes based, at least in part, on the corresponding set of node features and the attention score. The prediction module 232 may generate the hard label prediction using the teacher ML model 220. The database 204 may be updated with the attention score and the hard label prediction corresponding to each node in the set of nodes in the graph. Now, the learning or the knowledge of the teacher ML model 220 can be distilled to the student ML model 222. To achieve this, the student ML model 222 is trained using the concept of curriculum learning. As may be understood, the phrase ‘curriculum learning’ refers to a process of training an ML model by providing the input data samples to the ML model in an increasing order of their difficulty level.

Thus, in one embodiment, the difficulty computing module 228 includes suitable logic and/or interfaces for accessing, for each node of the set of nodes in the graph, the set of node features, a class label, and the attention score from the database 204. The class label may include one of the predefined label and the hard label prediction.

In another embodiment, the difficulty computing module 228 is configured to determine a difficulty metric for each node based, at least in part, on the corresponding set of node features and the corresponding class label. More specifically, for determining the difficulty metric, in one embodiment, the difficulty computing module 228 is configured to determine a label metric for each node based, at least in part, on the corresponding class label. In another embodiment, the difficulty computing module 228 is configured to determine a feature metric for each node based, at least in part, on the corresponding set of node features. In yet another embodiment, the difficulty computing module 228 is configured to compute the difficulty metric based, at least in part on the label metric and the feature metric.

In one embodiment, to determine the label metric, the difficulty computing module 228 is configured to identify one or more neighbor nodes of each node. Further, the difficulty computing module 228 may determine a class label corresponding to each neighbor node of the one or more neighbor nodes. Then, the difficulty computing module 228 may compute the label metric based, at least in part, on the corresponding class label of each node and the class label corresponding to each neighbor node.

In another embodiment, to determine the feature metric, the difficulty computing module 228 is configured to segregate a first subset of nodes associated with a first class label and a second subset of nodes associated with a second class label from the set of nodes based, at least in part, on the class label associated with each node. Further, the difficulty computing module 228 may extract, from the teacher ML model 220, a first subset of teacher node embeddings for the corresponding first subset of nodes and a second subset of teacher node embeddings for the corresponding second subset of nodes based, at least in part, on a set of teacher node embeddings of the set of nodes. Thereafter, the difficulty computing module 228 may generate a first class representation representing a first class of the first subset of nodes based, at least in part, on an aggregation of the first subset of teacher node embeddings. Then, the difficulty computing module 228 may generate a second class representation representing a second class of the second subset of nodes based, at least in part, on the aggregation of the second subset of teacher node embeddings. The difficulty computing module 228 may compute the feature metric based, at least in part, on comparing the first class representation, the second class representation, and a teacher node embedding corresponding to each node. It is noted that the difficulty metric may be provided to the training module 230 for training the student ML model 222 based on the difficulty metric of each node.

In an embodiment, the training module 230 is configured to generate a sequence of node batches for training the student ML model 222 based, at least in part, on the difficulty metric of each node. Each node batch may include a subset of nodes from the set of nodes in a predefined difficulty metric range associated with each node batch. Herein, each subsequent node batch in the sequence of node batches may include the subset of nodes in the predefined difficulty metric range for the subsequent node batch along with the subset of nodes corresponding to the one or more previous node batches in the sequence of node batches. Also, the predefined difficulty metric range in the subsequent node batch is larger than the predefined difficulty metric range of a previous node batch in the sequence of node batches. For example, a first node batch can include 10 nodes with the predefined difficulty metric range between a first value and a second value (e.g., 1 to 5) with the second value being greater than the first value. The second node batch can include the nodes from the first node batch, i.e., the 10 nodes along with new nodes such as new 10 nodes with the predefined difficulty metric range between a third value and a fourth value (e.g., 6 to 10) with the third value being greater than or equal to the second value, and the fourth value being greater than the third value, and so on.

In another embodiment, the training module 230 is configured to initialize the student ML model 222 based, at least in part, on one or more student model parameters. Herein, the student model parameters may be configured based on the type of the ML model used for the implementation of the student ML model 222. For example, for the student ML model 222 being an MLP, the student model parameters can be weights, biases, activation function parameters, learning rate, a number of layers in an NN of the MLP, a number of neurons in each layer, a number of epochs (or iterations), a batch size in each epoch, and the like.

In yet another embodiment, the training module 230 is configured to train the student ML model 222 to obtain a trained student ML model (not shown in FIG. 2) based, at least in part, on performing the first set of operations iteratively until the predefined criterion is met. In a non-limiting implementation, the first set of operations may include: (i) selecting a node batch from the sequence of node batches; (ii) generating, by the student ML model 222, a set of node embeddings for the subset of nodes based, at least in part, on the set of node features of each node in the selected node batch; (iii) determining, by the student ML model 222, a set of positive embedding pairs and a set of negative embedding pairs from the set of node embeddings based, at least in part, on the attention score of each node in the subset of nodes; (iv) computing one or more losses including at least an attention-aided contrastive loss, wherein the attention-aided contrastive loss is computed by an attention-aided contrastive loss function based, at least in part, on the set of positive embedding pairs and the set of negative embedding pairs; and (v) optimizing the student model parameters based, at least in part, on the one or more losses. Also, herein, for a subsequent iteration, a subsequent node batch is selected from the sequence of node batches.

In a non-limiting implementation, to determine the set of positive embedding pairs, the training module 230 may select at least one node from the node batch as the reference node. The reference can be selected randomly by the training module 230. Then, the training module 230 may access a set of reference node features associated with the reference node from the database 204. Further, the training module 230 may generate a reference node embedding for the reference node based, at least in part, on the set of reference node features. Furthermore, the training module 230 may identify a first subset of node embeddings from the set of node embeddings that are related to the reference node embedding based, at least in part, on the class label of each node in the node batch to obtain the set of positive embedding pairs.

In another non-limiting implementation, to determine the set of negative embedding pairs, the training module 230 may identify a second subset of node embeddings from the set of node embeddings that are unrelated to the reference node embedding based, at least in part, on the class label of each node in the node batch to obtain the set of negative embedding pairs.

In some embodiments, the training module 230 can also be configured to compute the one or more losses such as a cross-entropy loss while training the student ML model 222. The phrase ‘cross-entropy loss’ refers to a difference between the predicted and actual probability distributions of a classification model. To compute the cross-entropy loss, the training module 230 may generate, by the student ML model 222, a set of probability scores for the subset of nodes based, at least in part, on the corresponding set of node embeddings. Further, the training module 230 may generate, by the student ML model 222, a prediction for each node in the subset of nodes based, at least in part, on the set of probability scores. Herein, the prediction may include a student-hard label prediction. Furthermore, the training module 230 may compute, by a cross-entropy loss function, the cross-entropy loss for each node based, at least in part, on the prediction and a ground truth label associated with the corresponding node.

In some other embodiment, the training module 230 can also be configured to compute the one or more losses such as a Kullback-Leibler (KL) divergence loss. The phrase ‘KL divergence loss’ refers to a loss that measures how different two probability distributions are. It can also be known as relative entropy. To compute the KL divergence loss, the training module 230 may generate, by the student ML model 222, a probability score for each node in the subset of nodes based, at least in part, on the corresponding set of node embeddings. Then, the training module 230 may extract, from the teacher ML model 220, a teacher probability score associated with the hard label prediction. The training module 230 may compute, by a KL divergence loss function, the KL divergence loss for each node based, at least in part, on the probability score and the teacher probability score of the corresponding node.

Further, the first set of operations may be performed iteratively until the predefined criterion is met. In one embodiment, the predefined criterion can correspond to a convergence of the student ML model 222. In a non-limiting example, the convergence of the student ML model 222 can correspond to a saturation of the one or more losses. The losses can be saturated after a plurality of iterations of the first set of operations is performed. Herein, the saturation may refer to a stage in the model training process after a certain number of iterations where a loss value becomes constant, i.e., the difference in the losses for one iteration and its subsequent iteration becomes the same or negligible. The losses of any model are associated with model performance, so, the less the value of the losses the better the model performance. Hence, certain parameters associated with the model may be modified to reduce the loss value, thereby improving the model performance. Upon completion of the training of the student ML model 222, the trained student ML model may be obtained which can be used for generating predictions for graph data without requiring access to the graph data. It is to be noted that mere access to node features and/or edge features extracted from the graph data is sufficient to generate predictions using the trained student ML model.

In a specific embodiment, the prediction module 232 is configured to receive a prediction request related to the downstream task for an entity (e.g., the entity 104(1)) associated with an individual node from the set of nodes. Further, the prediction module 232 may be configured to generate a task-specific prediction corresponding to the downstream task for the individual node based, at least in part, on a corresponding plurality of node features of the individual node. In a non-limiting implementation, the prediction module 232 may generate the task-specific prediction by the trained student ML model associated with the server system 200.

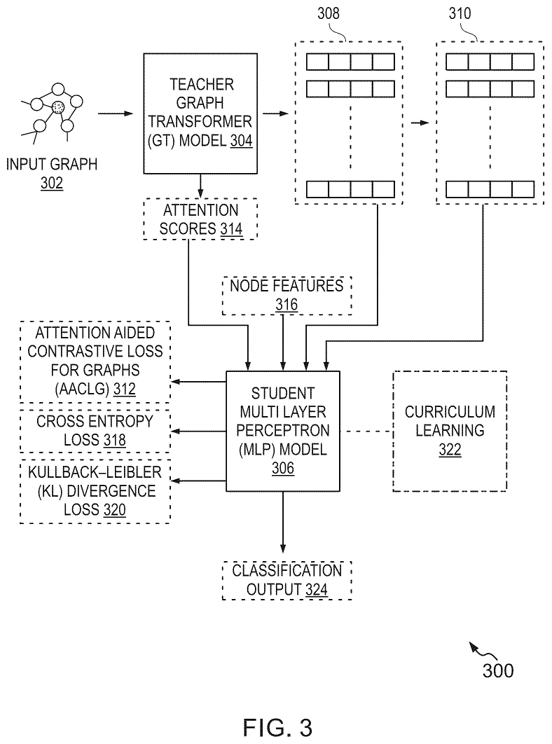

FIG. 3 illustrates a schematic representation of an architecture 300 for training an ML model such as the student ML model 110 with graph structure information, in accordance with an embodiment of the present disclosure. In a non-limiting implementation, the downstream task can be a node classification task. Further, for the node classification task, an input graph such as the input graph 302 with the set of nodes being N nodes can be considered. The input graph 302 can be characterized by G=(V,A,X) where V denotes the set of nodes v∈V, A∈ [symbol] ^{N×N} denotes an adjacency matrix with each entry A₄ₖ₀ being 1 if nodes u, v are connected, and 0 if not connected. Further, X∈ [symbol] ^{N×D} denotes the node feature matrix with each row being the node feature vector x_{b} with dimension D for node v∈V. Furthermore, Y∈ [symbol] ^{N×C} can be used to represent the node targets with each row corresponding to the C-dimensional one-hot vector y₀ for node v∈V. The subset of nodes from the set of nodes that are labeled are marked by the superscript L, that is, V^{L}, X^{L}, Y^{L} and similarly, the unlabeled nodes are marked by the superscript U, that is, V^{U}, X^{U}, Y^{U}. It is noted that the input graph 302 can be obtained from the entity-related dataset 218 associated with the entities 104 using the data pre-processing module 226 of the server system 200.

In one embodiment, the teacher ML model 220 can be a Graph Transformer (GT) 304 (otherwise, also referred to as a ‘teacher GT model’). The input graph 302 can be provided as an input to the GT 304. As may be understood, GTs extend the concept of self-attention mechanisms to graph-structured data, enabling the learning of node representations that capture both local and global graph structure. For a node v in a graph G with a node feature xᵥ, the representation

$${h}_{v}^{( ℓ )}$$

at layer [symbol] is updated using the GT 304. The update rule at each layer in the GT 304 is defined as:

$${h}_{0}^{( ℓ + 1 )} = {⊕}_{h = 1}^{H} {O}_{ℓ}^{h} ( {\sum }_{j ∈ G} {a}_{v j}^{ℓ , h} {h}_{J}^{( ℓ )} ) \qquad Eqn . ( 1 )$$

Here,

$${a}_{v j}^{ℓ , h}$$

is the attention coefficient computed as:

$${α}_{v j}^{ℓ , h} = {softmax}_{j} ( \frac{{( {Q}^{ℓ , h} {h}_{v}^{( ℓ )} )}^{T} ( {K}^{ℓ , h} {h}_{j}^{( ℓ )} )}{\sqrt{{d}_{k}}} ) \qquad Eqn . ( 2 )$$

In these equations,

$${Q}_{l}^{h}$$

is the output transformation matrix for head h at layer [symbol] and [symbol] are the query and key matrices for head h respectively and dₖ is the dimension of the key vector. This process iteratively updates the node representations, enriching them with information aggregated from their respective neighborhoods, weighted by the attention mechanism.

There are two key components in the approach proposed in the present disclosure, such as Attention Aided Contrastive Loss for Graphs (AACLG) and a Curriculum Learning Powered Distillation (CLPD) framework based on ranking node difficulties for efficient distillation. Further, as may be understood, the knowledge distillation process includes two steps. In the first step, training the teacher ML model 220 (i.e., the GT 304) on a subset of labeled nodes V^{L} from the set of nodes v∈V. The GT 304 may be trained using the training module 230 of the server system 200. In an example, the GT 304 with quadratic complexity can be considered. It is noted that irrespective of the choice, the training process remains consistent. It involves training the GT 304 employing a standard cross-entropy loss. In a non-limiting implementation, the standard cross-entropy loss can be computed using the following formula:

$$L = {\sum }_{v ∈ {V}^{L}} {L}_{C E} ( {\hat{y}}_{0} , {y}_{0} ) \qquad Eqn . ( 3 )$$

In the second step, the student ML model 222 such as a student MLP model 306 is trained to replicate the predictions of the already trained GT 304. To achieve this, soft labels zₚ (see, 308) are generated for each node v∈V using the trained GT 304. Given these soft labels zᵥ and hard labels y (see, 310) for nodes in V^{L}, a simple and lightweight MLP, i.e., the student MLP model 306 is trained.

As described earlier, conventional graph distillation approaches, such as GLNN, which lie within the realm of graph-structure-independence, are solely concentrated on mimicking the teacher model's output, neglecting to induce any structural information to the student MLP. Conversely, techniques such as NOSMOG do provide explicit structural insights into the student model through positional encodings. Yet, these methods depend on graph structural data (such as adjacency information) at the time of inference, leading to increased space complexity. Consequently, it is crucial to devise a strategy that integrates structural elements into the student MLP model while maintaining graph-structure independence during inference.

To address the above-mentioned problems, in the realm of contrastive learning, a contrastive loss function has emerged as a cornerstone, particularly for its efficacy in learning powerful representations by contrasting positive examples against negative ones. This principle is utilized in several conventional techniques as well. One such approach includes a Graph-MLP which has developed a neighborhood contrastive loss and facilitates MLPs to reach GNN-level performance without explicit message passing.

Advancing this concept, the attention-aided contrastive loss (otherwise, also referred to as ‘Attention Aided Contrastive Loss for Graphs (AACLG)’) (see, 312) is proposed in the present disclosure. The training module 230 of the server system 200 trains the student MLP model 306 using the one or more losses including at least the AACLG. The AACLG is aimed at distilling the essence of GTs to MLPs. This loss function integrates the attention mechanisms inherent in GTs, leveraging the nuanced attention scores (see, 314) along with the node features (see, 316) associated with each node in the input graph 302 to guide the MLP's learning process. AACLG is premised on the notion that the attention scores 314 generated by the GT 304 encapsulate critical relational insights, reflecting the importance of each node in the context of the entire graph i.e., the input graph 302. These attention scores 314 provide a rich, continuous spectrum of relational significance, more informative than the binary distinctions of connectivity used in traditional contrastive learning methods.

It is noted that, for each node v in the input graph 302, the GT 304 computes attention scores Attᵥᵤ, signifying the importance of node u to node v. In the AACLG framework, these attention scores dynamically define the ‘positiveness’ and ‘negativeness’ of examples (or embeddings) for node v, making the contrastive learning process attention-aware and contextually rich. AACLG tries to push node pairs with higher attention scores to be closer in the MLP's node representation space, i.e., the set of positive embedding pairs.

Further, to efficiently integrate structural insights, an adaptive thresholding strategy can be adapted for batching. For a given node v, a batch (or a node batch) is selected dynamically based on the distribution of attention scores Attᵥᵤ across the input graph 302. This batch consists of nodes with attention scores above a high threshold θ_{high} and below a low threshold θ_{low}, as well as a random selection from the remaining nodes to ensure a representative sample of the graph's relational dynamics. Within this batch, the attention scores are normalized to sum to one, maintaining the relative importance of each node's contribution. In a non-limiting implementation, the AACLG for the node v can be expressed as:

$${L}_{AACLG} = - {\sum }_{u ∈ B ( v )} \cdot log ( \frac{exp ( sim ( {h}_{v} , {h}_{u} ) / τ )}{{\sum }_{k ∈ B ( v )} exp ( sim ( {h}_{v} , {h}_{k} ) / τ )} ) \qquad Eqn . ( 4 )$$

Here, B(v) represents the adaptively selected batch for node v, [symbol] is the normalized attention weight, t is the temperature parameter, sim represents the cosine similarity and hᵤ represents the output from the penultimate layer of the MLP for a particular node u.

In one embodiment, along with the AACLG, the losses can also include the cross-entropy loss (see, 318) and the KL divergence loss (see, 320). Thus, in a non-limiting implementation, the total loss for a given training batch B from the labeled node set V^{L} can be a weighted amalgamation of the cross-entropy loss L_{CE} the AACLG, and the KL divergence loss which can be expressed as:

$${L}_{v} = {λ}_{1} {\sum }_{v ∈ B} {L}_{CE} ( {\hat{φ}}_{v} , {y}_{v} ) + {λ}_{2} {\sum }_{v ∈ B} {L}_{AACLG} ( {h}_{v} , {\{ {h}_{u} \}}_{u ∈ B ∖ \{ v \}} , {\{ \}}_{u ∈ B \{ \{ v \}} ) + ( 2 - {λ}_{1} - {λ}_{2} ) {L}_{KL} ( {\hat{φ}}_{v} , {z}_{v} ) \qquad Eqn . ( 5 )$$

Here, L_{CE} is the cross-entropy loss, L_{KL} is the KL divergence and L_{AACLG} is the attention aided contrastive loss. y₀ represents the actual label (i.e., the ground truth label) of node v, and \hat{φ}₀ is the predicted label from the MLP's final layer. The batch B includes nodes from the labeled subset V^{L}. In this formulation, hᵥ denotes the embedding of node v from the MLP's penultimate layer, {hᵤ}_{u∈B\{(v)} represents the embeddings of other nodes in the batch, and { [symbol] }_{u∈B,{(v)}} are the corresponding normalized attention weights. The parameters λ₁ and λ₂ are balancing factors between 0 and 1, tuning the relative impact of cross-entropy, AACLG, and KL divergence components within the overall loss function. This approach, integrating AACLG with adaptive thresholding and normalization, ensures that the student MLP model 306 learns not only the output predictions of the GT 304 but also the structural and relational intricacies captured by the GT's attention mechanism, thereby enhancing the MLP's performance in graph-based tasks. Further, as described earlier, the CLPD (see, curriculum learning 322) is also implemented in the present disclosure, while training the student MLP model 306 which is explained later in the present disclosure. Once the student MLP model 306 is trained, a trained student MLP model is obtained which can be used to perform the downstream task such as the node classification task, thereby obtaining classification output 324.

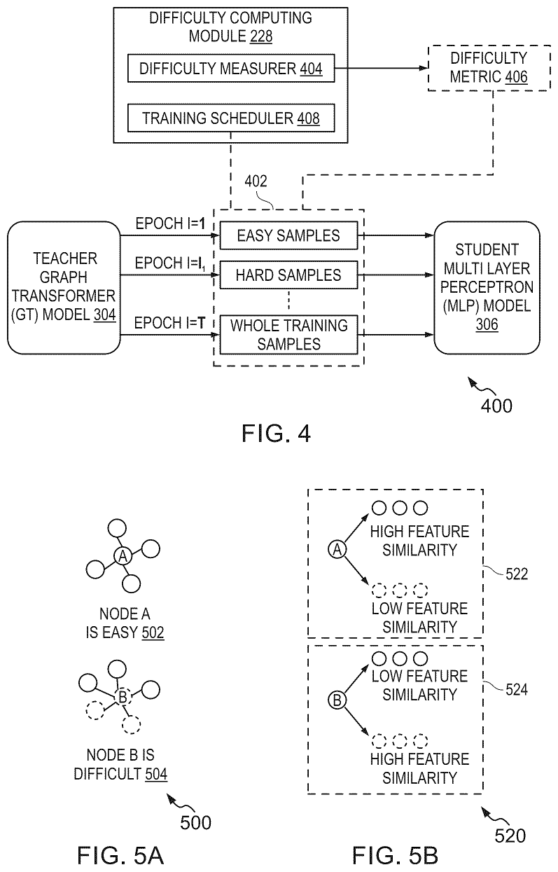

FIG. 4 illustrates a block diagram of a curriculum learning framework 400 for knowledge distillation, in accordance with an embodiment of the present disclosure. It is noted that the curriculum learning framework 400 shown in FIG. 4 is an example implementation for the CLPD 320 shown in FIG. 3. As may be understood, curriculum learning defines a sequence containing subsets of training examples, such as C= [symbol] Q₁, . . . . Q_{I}, Q_{T} [symbol] over T training steps (or epochs), such that Q_{I} denotes the training samples for the student MLP model 306 at step I. The sequence is ordered such that initial subsets, say Q₁, consist of easier samples, gradually adding harder samples as I progresses (see, 402). This is accomplished using two key components, a difficulty measurer 404 for scoring complexity (i.e., a difficulty metric such as a difficulty metric 406) of each training example and a training scheduler 408 for presenting the sorted examples in the desired sequence at a pace suitable for the network. It is noted that the difficulty measurer 404 and the training scheduler 408 are components of the difficulty computing module 228.

In a non-limiting implementation, the difficulty measurer 404 may assess a node difficulty (i.e., the difficulty metric 406) by analyzing the training graph and its hidden representations learned by the teacher GT model 304. In another non-limiting implementation, the training scheduler 408 may define a sequence of training subsets [symbol] Q₁, . . . , Qₜ . . . , Q_{T} [symbol] over T training epochs, progressively introducing complex nodes (see, 402).

More specifically, the difficulty computing module 228 may compute the difficulty metric 406 based on the label metric and the feature metric. The difficult metric is based on two metrics for comprehensive evaluation of node complexity using their label information and feature representation. Augmented labels Y_{aug} are created for each node in the input graph 302 using ground truth labels and predictions of the teacher GT model 304, such that,

$${Y}_{aug} = \{ \begin{matrix}{y}_{0} & ground truth class , for labeled nodes \\ {\hat{y}}_{0} & teacher ’ s prediction , for unlabeled nodes\end{matrix} \qquad Eqn . ( 6 )$$

In one embodiment, to compute the label metric, the label diversity in a node's neighborhood can be considered. Thus, the difficulty computing module 228 may compute the label metric by identifying neighbor nodes and determining the class label associated with each neighbor node. Then, the difficulty computing module 228 may compare the class label of the node with the class label of the neighbor nodes. If the class label of the node matches with the class label of the neighbor nodes, then said node is an easy node. Alternatively, if the class label of the node mismatches with the class label of the neighbor nodes, then said node is a difficult node.

Referring to FIG. 5A, illustrates a schematic representation 500 of determining the label metric for a node in a graph such as the input graph 302, in accordance with an embodiment of the present disclosure. It is observed in FIG. 5A that neighboring nodes of a node A are represented by the same type of circles, indicating that both the node A and its neighboring nodes belong to the same class. Thus, the node A is classified to be an easy node, and hence such nodes can be considered in the easy samples and passed earlier while the training process of the student ML model 306 (see, node A is easy 502).

Similarly, some neighboring nodes of a node B are represented differently from the rest of the neighboring nodes, indicating that the node B is surrounded by a variety of nodes. As a result, the node B can be classified as a difficult node, and such nodes can be considered in the difficult samples and passed after the easy samples are passed through the student ML model 306 (see, node B is difficult 504).

In other words, a node surrounded by neighbors with varying labels is considered more challenging. In a non-limiting implementation, the label metric can be quantified by calculating the distribution dc (v) of each class c, within the neighborhood N (v) and then the label metric can be determined using entropy. In an example, the distribution and the label metric equations can be expressed as follows:

$${d}_{c} ( 0 ) = \frac{{\sum }_{u ∈ N ( v )} 1 ( {Y}_{aug} ( u ) = c )}{\vert N ( v ) \vert} \qquad Eqn . ( 7 )$$

$${D}_{lalel} ( v ) = - {\sum }_{c ∈ C} {d}_{c} ( v ) log ( {d}_{c} ( v ) ) \qquad Eqn . ( 8 )$$

Here, 1(Y_{aug} (u)=c) is the indicator function. In a non-limiting scenario, there is a chance that the class label assigned by the teacher GT model 304 to the node A or node B is incorrect. In such a scenario, the feature metric can be used. Referring to FIG. 5B, illustrates a schematic representation 520 of determining the feature metric for a node in a graph such as the input graph 302, in accordance with an embodiment of the present disclosure. It is noted that the feature metric accounts for potential misclassification in Y_{aug} by the teacher GT model 304, by focusing on feature consistency between a node and aggregated features H_{c} of its label class. For example, inaccurate predictions for node A in FIG. 5A would increase the label-based difficulty for all its neighbors. To mitigate this concern, features of the nodes can be leveraged based on the assumption that node features inconsistent with representative features of their class are mislabelled. To this end, node representations can be learned by the teacher GT model 304, and consider nodes having higher misalignment with H_{c} as difficult (see, 522 and 524). Such nodes are likely to lie near the decision boundaries and are found difficult even by the teacher GT model 304. In an example, the distribution of the aggregated features and the feature metric equations can be expressed as follows:

$${H}_{c} = \frac{1}{\vert {V}_{c} \vert} {\sum }_{v ∈ {V}_{c}} {h}_{v} where {V}_{c} = \{ v ∈ V : {Y}_{aug} ( v ) = c \} \qquad Eqn . ( 9 )$$

$${D}_{feature} ( 0 ) = 1 - \frac{exp ( {h}_{v} \cdot {H}_{c} )}{{max}_{{c}_{t} ∈ C} exp ( {h}_{v} \cdot {H}_{{c}_{t}} )} \qquad Eqn . ( 10 )$$

Here, H_{c} is the mean feature vector for all nodes v in class c, with V_{c} denoting the set of nodes in class c.

Returning back to FIG. 4, the training scheduler 408 may organize nodes by increasing difficulty, leveraging a linear pacing function to determine the proportion of nodes used at each training epoch I, starting with the easiest nodes and adding difficult nodes at a uniform rate. In an example, the rate at which the nodes get added to the node batches during each epoch can be expressed as follows:

$$f ( t ) = min ( 1 , {N}_{0} + ( 1 - {N}_{0} ) \frac{t}{T} ) \qquad Eqn . ( 11 )$$

Here, N₀, t, T denote the fraction of easiest nodes available for training in the first step, current step, and total number of training steps respectively.

It is noted that the training proceeds with this increasing difficulty until the student MLP model 306 achieves convergence, ensuring a structured learning curve. Further, it is possible to keep training the student MLP model 306 with all nodes (I≥T) until convergence is reached. Herein, the term ‘convergence’ indicates the predefined criterion associated with the student ML model 306 as explained earlier. In other words, the student ML model 306 is trained to maximize its performance on a held-out validation dataset. Performance on the validation dataset is evaluated after every epoch. Further, training is stopped once the model such as the student ML model 306 has been trained for a predefined maximum number of epochs or when the validation performance stabilizes (i.e., no improvement for ‘n’ epochs with ‘n’ being a hyperparameter commonly referred to as patience).

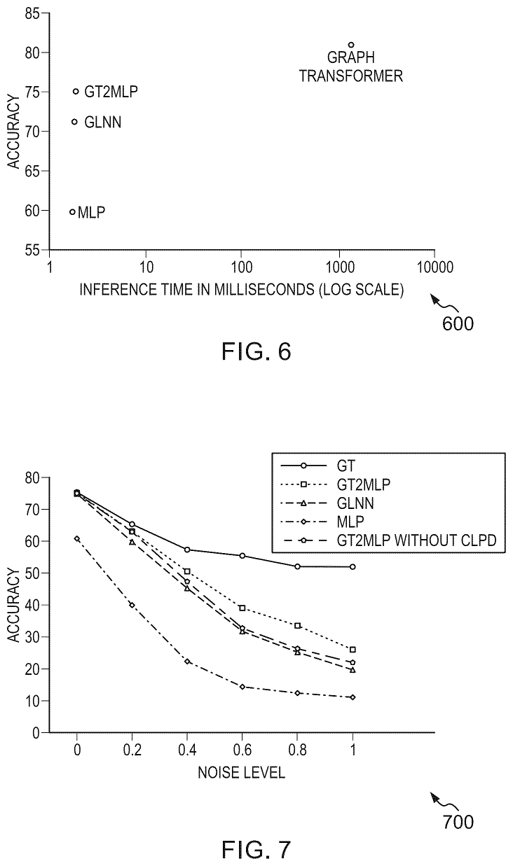

FIG. 6 illustrates a graphical representation of a comparative analysis 600 of a variation of an accuracy with an inference time for different ML models, in accordance with an embodiment of the present disclosure. The different ML models may include a GLNN, the GT, the MLP, and the GT2MLP. In a non-limiting implementation, various experiments have been conducted to verify the operation of the student ML model 222. For conducting the experiments, three widely used public benchmark datasets, such as Cora, Citeseer, and Pubmed, and two large OGB datasets, such as Arxiv and Products have been used. In a non-limiting implementation, Table 1 demonstrates the variation in attributes of these datasets, including number of nodes and classes. It is noted that, generally, a small subset of nodes is labeled and used for training the teacher ML model 220.

TABLE 1
Statistics of the datasets

| Dataset | #Nodes | #Edges | #Features | #Classes |
|---|---|---|---|---|
| Cora | 2485 | 5069 | 1433 | 7 |
| Citeseer | 2110 | 3668 | 3703 | 6 |
| Pubmed | 19717 | 44324 | 500 | 3 |
| Arxiv | 169343 | 1166243 | 128 | 40 |
| Products | 2449029 | 61859140 | 100 | 47 |

It is noted that the values of the attributes shown in Table 1 are approximate in nature and may vary by a factor of ±5% due to various experimental conditions.

Further, the Graph Transformer architecture is used as the teacher ML model 220, which uses Laplacian eigenvectors as the positional encodings. To maintain a fair comparison of the student ML model 222, the architectural choice made in GLNN i.e., the MLP model 306 is retained in the present disclosure. Furthermore, in a non-limiting implementation, the experiments are performed in PyTorch® with DGL, on a Dual AMD Rome 7742 processor (128 cores, 2.25 GHz) and NVIDIA A100 GPU (20 GB memory), using Adam optimizer.

Upon conducting the experiments, the average and standard deviation over ten runs with different random seeds for all experiments may be reported. It is noted that the accuracy is used as the evaluation metric, reported on test data, and the model selected using validation data. To evaluate the student ML model 222, a node classification is conducted in transudative and inductive settings. Transductively, the student ML model 222 is trained on graph G with labeled nodes X^{L} and Y^{L}, and evaluated on unlabeled nodes X^{U} and Y^{U}. Inductively, following GLNN, 20% of test data is set for inductive testing, splitting V^{U} into into

$${V}_{obs}^{U} and {G}_{ind}^{U} ,$$

forming three distinct graphs

$$G = {G}^{L} ⋃ {G}_{obs}^{U} ⋃ {G}_{ind}^{U}$$

and their feature and label sets

$$X = {X}^{L} ⋃ {X}_{obs}^{U} ⋃ {X}_{ind}^{U} and Y = {Y}^{L} ⋃ {Y}_{obs}^{U} ⋃ {Y}_{ind}^{U} .$$

Moreover, to comprehensively evaluate student ML model 222, node classification is performed under two settings, such as transductive (tran) and inductive (ind). In the transductive scenario, the model training is executed on the graph G, using the labeled nodes' features X^{L} and labels Y^{L}, and the evaluation is conducted on the features X^{U} and labels Y^{U} of the unlabeled nodes. For each node in the graph, soft labels are generated. In the inductive scenario, adhering to the methodology of GLNN, 20% of the test data is randomly designated for inductive testing. This involves splitting the unlabeled nodes V^{U} into two disjoint subsets: the observed subset

$${V}_{obs}^{U}$$

and the inductive sunset

$${G}_{ind}^{U} ,$$

thereby creating three separate graphs

$$G = {G}^{L} ⋃ {G}_{obs}^{U} ⋃ {G}_{ind}^{U}$$

with no overlapping nodes. Consequently, the node features and labels are divided into three distinct sets:

$$X = {X}^{L} ⋃ {X}_{obs}^{U} ⋃ {X}_{ind}^{U} and Y = {Y}^{L} ⋃ {Y}_{ops}^{U} ⋃ {Y}_{ind}^{U} .$$

It may be observed that NOSMOG is not considered among the different models whose accuracy is compared with each other to check which model outperforms the rest of the models. NOSMOG is not a suitable choice for evaluating the efficacy of distillation methods, especially when the focus is on the scalability of models in production environments. NOSMOG, while offering structural insights through explicit graph data utilization, relies heavily on adjacency information at inference time, which can significantly increase space complexity. This reliance contradicts the desired attribute of graph-structure-independence during inference, a principle that is crucial for efficient and scalable model deployment. Furthermore, while comparing different models such as GIs, GNNs, and MLPs, it is crucial to consider both space and time complexities. NOSMOG and similar approaches might achieve a balance between accuracy and time complexity, but they tend to neglect the impact on space complexity, a significant concern in resource-constrained settings. Specifically, despite being an MLP, NOSMOG may incur higher space complexity due to the requirement to load graph structures for processing, contrasting with approaches like GLNN or GT2MLP, which are designed to operate without storing the entire graph in memory during inference.

In the comparative analysis, GT2MLP is evaluated against GT (Vanilla Graph Transformer), MLP, and the leading method GLNN, within an identical experimental framework. In a non-limiting implementation, the accuracy observed for the different models under consideration for the model combinations is as follows:

TABLE 2
Accuracy across different datasets

| Dataset | GT | MLP | GLNN | GT2MLP | Δ_{MLP} | Δ_{GT} | Δ_{GLNN} |
|---|---|---|---|---|---|---|---|
| Cora | 87.54 ± 1.77 | 59.22 ± 1.68 | 88.45 ± 1.44 | 89.66 ± 1.22 | 30.44 | 2.12 | 1.21 |
| Citeseer | 76.63 ± 1.72 | 59.61 ± 1.63 | 77.39 ± 1.39 | 79.17 ± 1.42 | 19.56 | 2.54 | 1.78 |
| Pubmed | 82.27 ± 2.18 | 67.55 ± 2.84 | 83.02 ± 2.56 | 84.56 ± 2.27 | 17.01 | 2.29 | 1.54 |
| arxiv | 74.89 ± 1.03 | 56.05 ± 1.36 | 68.61 ± 1.23 | 72.21 ± 0.60 | 16.16 | −2.68 | 3.6 |
| products | 80.94 ± 0.89 | 62.47 ± 1.29 | 71.22 ± 1.3 | 75.06 ± 0.71 | 12.59 | −5.88 | 3.84 |

As illustrated in Table 2, GT2MLP significantly outshines MLPs of comparable complexity, achieving an average improvement of 19.15% across five datasets. Furthermore, GT2MLP surpasses the cutting-edge GLNN method by an average margin of 2.4% across all the datasets, including Arxiv and Products, indicating its superior capability in capturing topological information. Impressively, GT2MLP provides a larger boost of 3.6% and 3.8% over GLNN on OGB datasets, proving its ability to effectively capture local and global interactions. Further, against the teacher GT model 304, GT2MLP exhibits an average improvement of 2.31% in the three Cora, Citeseer, and Pubmed datasets, albeit it lags in the two OGB datasets. The performance disparity observed in the much larger OGB datasets can be attributed to the significant shift in data distribution between the training and testing phases and the classical trade-off between model complexity and accuracy. As our comparison involves models of similar complexity and slightly less performance on OGB datasets is anticipated. An enhancement in accuracy is achievable at the cost of increased inference time by expanding the size of the student MLP model 306. It is noted that the results shown in Table 2 are approximate in nature and may vary by a factor of ±5% due to various experimental conditions.

Furthermore, a comparative analysis may be conducted to evaluate the performance of GT2MLP, with a particular emphasis on how its predictive accuracy aligns with its operational speed. The analysis was performed using the products dataset, as shown in FIG. 6. GT2MLP demonstrated commendable results, achieving an accuracy of 75.06% and a rapid inference speed of 1.9 milliseconds which is 712× faster than the teacher GT model 304. In comparison to its counterparts, GT2MLP exhibits superior performance within the same operational duration. For instance, other models like GLNN and MLPs only achieved 71.22% and 62.47% accuracy, respectively. Moreover, models that attain accuracy comparable to that of GT2MLP necessitate a considerably longer inference time, highlighting GT2MLP's outstanding efficiency.

In the comparative analysis, ablation experiments may be conducted to assess the impact of distinct elements within GT2MLP, namely the Attention Aided Contrastive Loss (AACLG) and Curriculum Learning Powered Distillation (CLPD), by isolating and removing each component to observe the effect on performance. In a non-limiting implementation, the results for the ablation experiments are as follows:

TABLE 3
Ablation experiment results

| Datasets | w/o AACLG | w/o CLPD | GT2MLP | Δ_{AACLG} | Δ_{CPLD} |
|---|---|---|---|---|---|
| Cora | 88.79 ± 1.36 | 88.99 ± 1.51 | 89.66 ± 1.22 | 0.87 | 0.67 |
| Citeseer | 78.04 ± 1.64 | 78.34 ± 1.49 | 79.17 ± 1.42 | 1.13 | 1.83 |
| Pubmed | 83.45 ± 1.93 | 83.78 ± 1.78 | 84.56 ± 2.27 | 1.11 | 0.78 |
| OGB-arxiv | 69.54 ± 0.87 | 71.12 ± 0.56 | 72.21 ± 0.60 | 2.67 | 1.09 |
| OGB-products | 72.1 ± 0.79 | 74.19 ± 0.63 | 75.06 ± 0.71 | 2.96 | 0.87 |

Referring to Table 3, a decline in performance with the removal of either component is observed, which underscores their individual effectiveness. It may be observed that, while both AACLG and CLPD significantly enhance performance, AACLG shows a greater impact on larger datasets like Arxiv and Products, where the role of global interactions is crucial. On the other hand, the CLPD component consistently boosts performance across all five datasets tested, demonstrating its effectiveness and broad applicability. It is noted that the results shown in Table 3 are approximate in nature and may vary by a factor of ±5% due to various experimental conditions.

FIG. 7 illustrates a graphical representation of a comparative analysis 700 of an impact of the curriculum learning framework on the noisy features of different ML models, in accordance with an embodiment of the present disclosure. In a non-limiting implementation, the presence of the noisy features can hamper the ability of standalone MLPs and GLNN to fit meaningful functions to the node features X and labels Y without considering adjacency information ‘A’. Further, using curriculum learning to exclude the low-quality noisy/difficult nodes in the initial stages of training improves generalization and hence prevents over-fitting to the noisy nodes. The inductive setting performance of GT2MLP with and without curriculum learning (CLPD) may be evaluated, against the teacher GT, GLNN, and MLP for different levels of Gaussian noise added to the node features to show the effectiveness of the curriculum learning. The node features X are replaced by X̅=(1−α)X+(α)n, where α is the noise level varying between [0,1] and n is the Gaussian noise independent from X.

It is noted that FIG. 7 demonstrates that while the performance of GT2MLP drops in comparison to GT with an increasing noise level, it maintains a higher performance with respect to GLNN, with a larger gap (approximately 6%) observed as we approach a peak noise level of 0.8 and above. Without using curriculum learning. GT2MLP also observes a drop in performance with noise similar to GLNN. With increasing noise levels, there is a significant gap in the performance of GT2MLP with and without CLPD proving that curriculum learning improves the model's robustness to noise.

Further, to evaluate the performance of GT2MLP in a real-world production environment (prod), tests in both inductive (ind) and transductive (tran) frameworks may be conducted. In a non-limiting implementation, results for the same are shown in the following table:

TABLE 4
Performance of different models in transductive,
inductive, and production settings

| Dataset | Setting | GT | MLP | GLNN | GT2MLP | Δ_{MLP} | Δ_{GT} | Δ_{GLNN} |
|---|---|---|---|---|---|---|---|---|
| Cora | prod | 87.34 | 58.98 | 86.33 | 88.19 | 29.21 | 0.85 | 1.86 |
| | ind | 88.23 | 59.09 | 80.72 | 84.07 | 24.98 | −4.16 | 3.35 |
| | tran | 87.12 | 58.95 | 87.73 | 89.22 | 30.27 | 2.10 | 2.31 |
| Citeseer | prod | 74.20 | 59.81 | 75.09 | 77.40 | 17.59 | 3.2 | 2.31 |
| | ind | 75.14 | 60.06 | 74.64 | 74.98 | 14.92 | −0.16 | 0.34 |
| | tran | 73.97 | 59.75 | 75.21 | 78.01 | 18.26 | 4.04 | 2.80 |
| Pubmed | prod | 81.63 | 66.80 | 81.57 | 83.35 | 16.55 | 1.72 | 1.78 |
| | ind | 81.93 | 66.85 | 80.96 | 81.43 | 14.58 | −0.50 | 0.47 |
| | tran | 81.56 | 66.79 | 81.72 | 83.83 | 17.04 | 2.27 | 2.11 |
| Arxiv | prod | 74.89 | 55.30 | 69.26 | 70.86 | 15.56 | −4.03 | 1.60 |
| | ind | 74.78 | 55.40 | 63.84 | 67.38 | 11.98 | −7.40 | 3.54 |
| | tran | 74.92 | 55.28 | 70.61 | 71.73 | 16.45 | −3.19 | 1.12 |
| Products | prod | 81.08 | 63.72 | 67.70 | 71.52 | 7.80 | −9.56 | 3.82 |
| | ind | 80.90 | 63.70 | 67.24 | 70.68 | 6.98 | −10.22 | 3.44 |
| | tran | 81.12 | 63.73 | 67.82 | 71.73 | 8.00 | −9.39 | 3.91 |

Referring to Table 4, it may be observed that, GT2MLP exhibited superior or equivalent performance compared to the teacher model in three of the five datasets tested. However, in the case of the Arxiv and Products datasets, GT2MLP lagged in all three settings. This performance gap can be attributed to the significant shift in data distribution between the training and testing phases, coupled with GT2MLP's lack of access to the graph structure during inference. Despite these challenges, GT2MLP outperformed GLNN on these datasets, with improvements of 1.6% and 3.82%, respectively, highlighting its ability to discern graph structural information in large-scale datasets amidst notable distribution shifts. Moreover, GT2MLP consistently surpassed both MLP and GLNN across all datasets and settings, achieving average enhancements of 17.34% and 2.27%, respectively. Thus, it is evident that GT2MLP is capable of delivering outstanding performance in production settings, encompassing both inductive and transductive settings.

Note that the results presented in the transductive setting differ from those shown in Table 2. In the standard transductive setting of Table 2, the model is trained on the entire graph G using features X and labels Y^{L}, and evaluate on all the unlabeled nodes, denoted X^{U} and Y^{U}. However, for the evaluation in the transductive setting as shown in Table 4, 20% of the testing data may be excluded, specifically

$${X}_{lnd}^{U} and {Y}_{Jnd}^{U}$$

and only evaluate the remaining 80% of the testing data, referred to as

$${X}_{obs}^{U} and {Y}_{ops}^{U} .$$

The adjustment data used for evaluation accounts for the differences in the results observed.

To conclude, it may be observed that the GT2MLP, a novel framework for distilling Graph Transformers (GTs) into efficient MLPs is proposed in the present disclosure. It is noted that the proposed approach leverages the AACLG and CLPD to transfer structural knowledge effectively. The proposed approach captures both local and global graph structures, optimizing learning through a curriculum learning strategy enhancing model generalization. Empirically, GT2MLP has been shown to significantly reduce inference times while maintaining or exceeding the accuracy of GT models and current benchmarks. Moreover, it is shown that CLPD helps in generalization and in dealing with noisy features, especially in inductive settings.

FIG. 8 illustrates a schematic representation of another environment 800 related to at least some example embodiments of the present disclosure. Although the environment 800 is presented in one arrangement, other embodiments may include the parts of the environment 800 (or other parts) arranged otherwise depending on, operations performed similar to that performed in the environment 100. Thus, it should be noted that the environment 800 is an example implementation of the environment 100, with the environment 800 representing a financial industry in which the entity 104(1) can be at least one of the cardholders and/or merchants. Thus, the plurality of data points or samples of events in the environment 100 may correspond to a plurality of payment transactions performed between the cardholders and the merchants in the environment 800.

In one embodiment, the environment 800 includes entities, such as the server system 102, a plurality of cardholders 802(1), 802(2), . . . 802(N) (collectively referred to hereinafter as the ‘plurality of cardholders 802’ or simply ‘cardholders 802’), a plurality of merchants 804(1), 804(2), . . . 804(N) (collectively referred to hereinafter as a ‘plurality of merchants 804’ or simply ‘merchants 804’), a plurality of issuer servers 806(1), 806(2), . . . 806(N) (collectively referred to hereinafter as the ‘plurality of issuer servers 806’ or simply ‘issuer servers 806’), a plurality of acquirer servers 808(1), 808(2), . . . 808(N) (collectively referred to hereinafter as the ‘plurality of acquirer servers 808’ or simply ‘acquirer servers 808’), a payment network 810 including a payment server 812, and a database 814 each coupled to, and in communication with (and/or with access to) the network 108. Herein, it may be noted that ‘N’ is a non-zero natural number that may be different for each entity.

As used herein, the term “cardholder” (such as cardholder 802(1)) refers to a person who has a payment account or a payment card (e.g., credit card, debit card, etc.,) associated with the payment account, that will be used by a merchant (such as the merchant 804(1)) to perform a payment transaction. The payment account may be opened via an issuing bank or an issuer server (e.g., the issuer server 806(1)). The term “merchant” refers to a seller, a retailer, a purchase location, an organization, or any other entity that is in the business of selling goods or providing services, and it can refer to either a single business location or a chain of business locations of the same entity. Further, as used herein, the term “payment network” refers to a network or collection of systems used for the transfer of funds through the use of cash substitutes. Payment networks (including payment network 810) are set up by companies or businesses that connect an issuing bank with an acquiring bank to facilitate digital payments between the cardholders 802 and the merchants 804. In an example, the cardholders 802 may use their corresponding electronic devices (not shown) to access a mobile application or a website associated with the merchants 804, or any third-party payment application to perform a payment transaction.

As may be understood, within the financial domain, the financial data can be represented in the form of a graph. The graph includes the nodes indicating the entities, such as the cardholders 802, the merchants 804, issuers, acquirers, and the like and edges indicating payment transactions performed between the entities. When the graph-based models, such as the GNNs, GTs, etc., among other models are used, generation of results during the inference stage get time-consuming, imposing limitations on deployment. Thus, the learned information from such graph-based models is distilled to smaller student models such as MLP through knowledge distillation. As a result, both competitive performance and faster inference can be achieved. Further, conventional approaches of distillation models are not suitable for GT architectures.

To address the above-mentioned and other problems, the server system 102 proposed in the present disclosure can be deployed in the payment server 812 associated with the payment network 810. In an implementation, the server system 102 is coupled with the database 814. In one embodiment, the server system 102 may facilitate payment processors operating the payment network 810 through the payment server 812 in training a student ML model such as the MLP with the graph structure information corresponding to the financial data associated with the cardholders 802. In some implementations, the server system 102 can be embodied within a payment server (e.g., the payment server 812) associated with the payment network 810 (owned by the payment processor), however, in other examples, the server system 102 can be a standalone component (acting as a hub) connected to the issuer servers 806 and the acquirer servers 808 as well.

In an embodiment, the database 814 may include a historical transaction dataset (not shown in FIG. 8), a teacher ML model (not shown in FIG. 8), a student ML model 816, and the like. The historical transaction dataset may include one or more transaction attributes related to the plurality of transactions performed between the cardholders 802 and the merchants 804. As may be understood, each cardholder (e.g., the cardholder 802(1)) can perform a plurality of transactions with different merchants. Herein, the number of transactions performed by each cardholder 802(1) may be different. The historical transaction dataset may be maintained and updated with information related to new transactions as they take place in real-time (or near real-time). In other words, the historical transaction dataset is a repository of information associated with all the transactions (or a subset of transactions) performed over a historical time period. It is noted that the plurality of transactions may refer to the plurality of data points or the plurality of events and the plurality of data fields may refer to the plurality of transaction attributes in this specific implementation. In various examples, the historical transaction dataset may include, but is not limited to, one or more transaction attributes for a plurality of transactions, such as transaction amount, source of funds such as bank accounts, debit cards or credit cards, transaction channel used for loading funds such as Point Of Sale (POS) terminal or Automated Teller Machine (ATM), transaction velocity features such as count and transaction amount sent in the past ‘x’ number of days to a particular user, external data sources, merchant country, merchant Identifier (ID), cardholder ID, cardholder product, cardholder Permanent Account Number (PAN), Merchant Category Code (MCC), merchant location data or merchant co-ordinates, merchant industry, merchant super industry, ticket price, and other transaction-related data.

In other various examples, the database 814 may also include multifarious data, for example, social media data, Know Your Customer (KYC) data, payment data, trade data, employee data, Anti Money Laundering (AML) data, market abuse data, Foreign Account Tax Compliance Act (FATCA) data, and fraudulent payment transaction data as well.

By accessing the historical transaction dataset from the database 814, a graph may be generated for training the teacher ML model for obtaining the node features, the class label, and the attention score associated with each node in the graph. This information is then used by the server system 102 to train the student ML model 816 using a novel approach proposed in the present disclosure. According to the novel approach, the server system 102 may perform various operations. It should be noted that the operations are explained above with reference to FIGS. 1, 2, 3, 4, 5A, and 5B, and not described again for the sake of brevity.

As may be appreciated, the approach described by the present disclosure can easily be scaled and applied to various downstream tasks specific to different industries with minor modifications. It is noted that such applications are also covered within the scope of the present disclosure. Another example of an application of the approach proposed in the present disclosure being applied in the transportation and logistics industry has been described with reference to FIG. 9.

FIG. 9 illustrates a schematic representation of another environment 900 related to at least some example embodiments of the present disclosure. Although the environment 900 is presented in one arrangement, other embodiments may include the parts of the environment 900 (or other parts) arranged otherwise depending on, operations performed similar to that performed in the environment 100. Thus, it should be noted that the environment 900 is an example implementation of the environment 100, with the environment 900 representing a transportation and logistics industry in which the entities 104 can be at least one of vehicles, drivers, warehouses, delivery locations, routes, customers, suppliers, and the like. Thus, the transactions of the environment 100 may correspond to routes traversed in a route-location network in the environment 900.

In one embodiment, the environment 900 includes components, such as the server system 102, a route-location network 902 having a plurality of location indicators, such as 904, 906, 908, 910, a plurality of routes 912A, 912B, 912C, 912D, 912E, and 912F, the database 914, and a transportation and logistics data server 916 each coupled to, and in communication with (and/or with access to) the network 108.

As used herein, the term “location indicator” refers to a unique identifier or a unique address indicating a geographic location of a source, a destination, or intermediate stops involved in transportation and logistics-related tasks. Further, the term “route” refers to a path between two nodes such as a source or a destination to commute between the two nodes.

In a non-limiting example, for commuting from one location to another, individuals use applications or websites that virtually show optimal routes for commutation between the corresponding locations. Such applications generate the optimal routes using AI or ML models that are trained using a predefined training dataset. In a non-limiting example, for training the AI or ML models to generate the optimal routes, the predefined training dataset may include location-tracking information, routes taken in the past, speed and direction changes, interaction events and purposes, weather conditions, vehicle movement patterns of multiple routes, traffic patterns, and the like.

In one embodiment, the predefined training dataset and the historical information associated with the transportation and logistics may be stored in the transportation and logistics data server 916. In some embodiments, the transportation and logistics data server 916 may be associated with a third-party agency or a transportation and logistics management agency that is involved in monitoring metrics associated with the transportation and logistics operations at one or more locations. It is noted that logistic managers and users requiring optimal route recommendations may use their corresponding electronic devices to access such applications or websites.

As described earlier, a traffic network can be represented in the form of a graph and provided to AI or ML models that can process graph data. Graphs can best represent any network as it covers relational information between two points in the network. However, such models require more inference time and cannot be used in real-time to generate instantaneous predictions to guide individuals using routes in the traffic network. As a result, the server system 102 proposed in the present disclosure can be used to distill the learning or knowledge of the graph-based model (a teacher ML model) to a smaller ML model, i.e., a student ML model 918 such as an MLP. Then, the student ML model 918 can be used to generate faster inferences.

Further, it may be noted that, in a specific example, the server system 102 coupled with the database 106 is embodied within the transportation and logistics data server 916, however, in other examples, the server system 102 can be a standalone component (acting as a hub) connected to the transportation and logistics data server 916. In an embodiment, the database 106 is configured to store the entity-related dataset 218. In another embodiment, the database 106 may also store the training dataset and other historical information associated with the transportation and logistics operations.

In one embodiment, the entity-related dataset 218 may include location-tracking information, routes taken in the past, speed and direction changes, interaction events and purposes, weather conditions, vehicle movement patterns of multiple routes, traffic patterns, and the like.

By accessing the entity-related dataset 218, the server system 102 is configured to train the student ML model 918 with the graph structure information by performing various operations. It should be noted that the operations are explained above with reference to FIGS. 1, 2, 3, 4, 5A, and 5B and not described again for the sake of brevity.

It is noted that although FIG. 8 and FIG. 9 describe specific applications of the various embodiments of the present disclosure, the same should not be construed as a limitation to the scope of the present disclosure. In other words, the various embodiments of the present invention can be utilized to perform various other suitable applications as well without departing from the scope of the present disclosure.

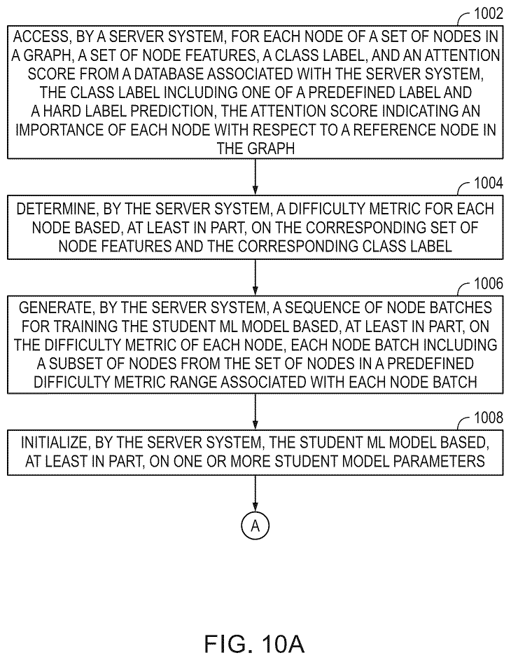

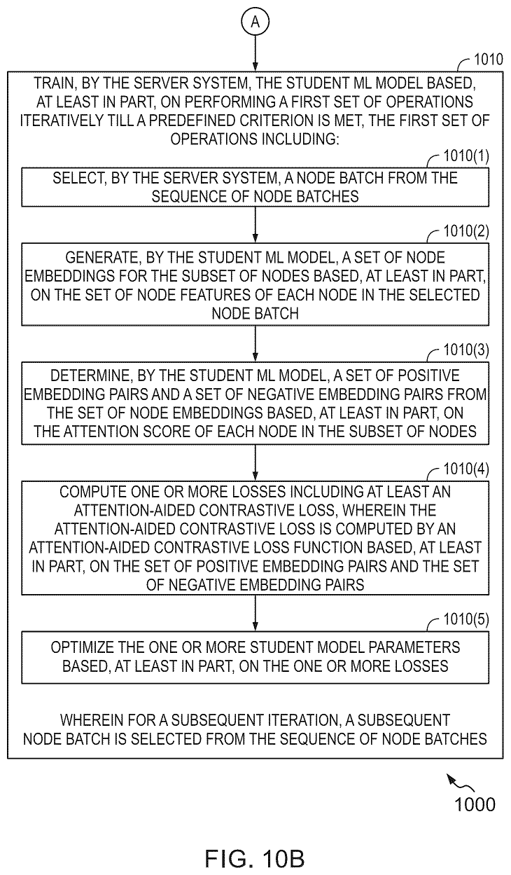

FIGS. 10A and 10B, collectively, illustrate a flow diagram depicting a method 1000 for training a student Machine Learning (ML) with graph structure information, in accordance with an embodiment of the present disclosure. The method 1000 depicted in the flow diagram may be executed by, for example, the server system 200. The sequence of operations of the method 1000 may not be necessarily executed in the same order as they are presented. Further, one or more operations may be grouped and performed in the form of a single step, or one operation may have several sub-steps that may be performed parallelly or sequentially. Operations of the method 1000, and combinations of operations in the method 1000 may be implemented by, for example, hardware, firmware, a processor, circuitry, and/or a different device associated with the execution of software that includes one or more computer program instructions. The plurality of operations is depicted in the process flow of the method 1000. The process flow starts at operation 1002.

At operation 1002, the method 1000 includes accessing, by a server system (e.g., the server system 200), for each node of a set of nodes in a graph (e.g., the input graph 302), a set of node features (e.g., the node features 316), a class label, and an attention score (e.g., the attention scores 314) from a database (e.g., the database 204) associated with the server system 200. The class label may include one of a predefined label and a hard label prediction (e.g., the hard labels 310). Further, the attention score may indicate an importance of each node with respect to a reference node in the graph such as the input graph 302.

At operation 1004, the method 1000 includes determining, by the server system 200, a difficulty metric (e.g., the difficulty metric 406) for each node based, at least in part, on the corresponding set of node features such as the node features 316 and the corresponding class label.

At operation 1006, the method 1000 includes generating, by the server system 200, a sequence of node batches for training the student ML model (e.g., the student ML model 222) based, at least in part, on the difficulty metric 406 of each node. Each node batch may include a subset of nodes from the set of nodes in a predefined difficulty metric range associated with each node batch.

At operation 1008, the method 1000 includes initializing, by the server system 200, the student ML model 222 based, at least in part, on one or more student model parameters.

At operation 1010, the method 1000 includes training, by the server system 200, the student ML model 222 to obtain a trained student ML model based, at least in part, on performing a first set of operations iteratively until a predefined criterion is met. The first set of operations may include 1010(1), 1010(2), 1010(3), 1010(4), and 1010(5).

At operation 1010(1), the method 1000 includes selecting, by the server system 200, a node batch from the sequence of node batches.

At operation 1010(2), the method 1000 includes generating, by the student ML model 222, a set of node embeddings for the subset of nodes based, at least in part, on the set of node features such as the node features 316 of each node in the selected node batch.

At operation 1010(3), the method 1000 includes determining, by the student ML model 222, a set of positive embedding pairs and a set of negative embedding pairs from the set of node embeddings based, at least in part, on the attention score of each node in the subset of nodes.

At operation 1010(4), the method 1000 includes computing one or more losses including at least an attention-aided contrastive loss (e.g., the Attention Aided Contrastive loss for Graphs (AACLG) 312). Herein, the attention-aided contrastive loss is computed by an attention-aided contrastive loss function based, at least in part, on the set of positive embedding pairs and the set of negative embedding pairs.

At operation 1010(5), the method 1000 includes optimizing the one or more student model parameters based, at least in part, on the one or more losses. Herein, for a subsequent iteration, a subsequent node batch is selected from the sequence of node batches.

The disclosed method with reference to FIGS. 10A and 10B, or one or more operations of the server system 200 may be implemented using software including computer-executable instructions stored on one or more computer-readable media (e.g., non-transitory computer-readable media, such as one or more optical media discs, volatile memory components (e.g., Dynamic Random Access Memory (DRAM) or Statis Random Access Memory (SRAM)), or nonvolatile memory or storage components (e.g., hard drives or solid-state nonvolatile memory components, such as Flash memory components) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication mode. Such a suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad scope of the invention. For example, the various operations, blocks, etc., described herein may be enabled and operated using hardware circuitry (for example, Complementary Metal Oxide Semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, Application-Specific Integrated Circuit (ASIC) circuitry and/or in Digital Signal Processor (DSP) circuitry).

Particularly, the server system 200 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or the computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media includes any type of tangible storage media. Examples of non-transitory computer-readable media include magnetic storage media (such as floppy disks, magnetic tapes, hard disk drives, etc.), optical magnetic storage media (e.g. magneto-optical disks), Compact Disc Read-Only Memory (CD-ROM), Compact Disc Recordable CD-R, Compact Disc Rewritable CD-R/W), Digital Versatile Disc (DVD), and semiconductor memories (such as mask ROM, programmable ROM (PROM), Erasable PROM (EPROM), flash memory, Random Access Memory (RAM), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different from those which are disclosed. Therefore, although the invention has been described based on these exemplary embodiments, it is noted that certain modifications, variations, and alternative constructions may be apparent and well within the scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method for training a student Machine Learning (ML) model, comprising:
accessing, by a server system, for each node of a set of nodes in a graph, a set of node features, a class label, and an attention score from a database associated with the server system, the class label comprising one of a predefined label and a hard label prediction, the attention score indicating an importance of each node with respect to a reference node in the graph;
determining, by the server system, a difficulty metric for each node based, at least in part, on the corresponding set of node features and the corresponding class label;
generating, by the server system, a sequence of node batches for training the student ML model based, at least in part, on the difficulty metric of each node, each node batch comprising a subset of nodes from the set of nodes in a predefined difficulty metric range associated with each node batch;
initializing, by the server system, the student ML model based, at least in part, on one or more student model parameters; and
training, by the server system, the student ML model to obtain a trained student ML model based, at least in part, on performing a first set of operations iteratively until a predefined criterion is met, the first set of operations comprising:
selecting, by the server system, a node batch from the sequence of node batches;
generating, by the student ML model, a set of node embeddings for the subset of nodes based, at least in part, on the set of node features of each node in the selected node batch;
determining, by the student ML model, a set of positive embedding pairs and a set of negative embedding pairs from the set of node embeddings based, at least in part, on the attention score of each node in the subset of nodes;
computing one or more losses comprising at least an attention-aided contrastive loss, wherein the attention-aided contrastive loss is computed by an attention-aided contrastive loss function based, at least in part, on the set of positive embedding pairs and the set of negative embedding pairs; and
optimizing the one or more student model parameters based, at least in part, on the one or more losses,
wherein for a subsequent iteration, a subsequent node batch is selected from the sequence of node batches.

2. The computer-implemented method as claimed in claim 1, wherein computing the one or more losses comprising at least a cross-entropy loss comprises:
generating, by the student ML model, a set of probability scores for the subset of nodes based, at least in part, on the corresponding set of node embeddings;
generating, by the student ML model, a a node class prediction for each node in the subset of nodes based, at least in part, on the set of probability scores, the node class prediction comprising a student-hard label prediction; and
computing, by a cross-entropy loss function, the cross-entropy loss for each node based, at least in part, on the node class prediction and a ground truth label associated with the corresponding node.

3. The computer-implemented method as claimed in claim 1, wherein computing the one or more losses comprising at least a Kullback-Leibler (KL) divergence loss comprises:
generating, by the student ML model, a probability score for each node in the subset of nodes based, at least in part, on the corresponding set of node embeddings;
extracting, from a teacher ML model associated with the server system, a teacher probability score associated with the hard label prediction; and
computing, by a KL divergence loss function, the KL divergence loss for each node based, at least in part, on the probability score and the teacher probability score of the corresponding node.

4. The computer-implemented method as claimed in claim 1, wherein determining the difficulty metric for each node comprises:
determining, by the server system, a label metric for each node based, at least in part, on the corresponding class label;
determining, by the server system, a feature metric for each node based, at least in part, on the corresponding set of node features; and
computing, by the server system, the difficulty metric based, at least in part on the label metric and the feature metric.

5. The computer-implemented method as claimed in claim 4, wherein determining the label metric for each node comprises:
identifying, by the server system, one or more neighbor nodes of each node;
determining, by the server system, a class label corresponding to each neighbor node of the one or more neighbor nodes; and
computing, by the server system, the label metric based, at least in part, on the corresponding class label of each node and the class label corresponding to each neighbor node.

6. The computer-implemented method as claimed in claim 4, wherein determining the feature metric for each node comprises:
segregating, by the server system, a first subset of nodes associated with a first class label and a second subset of nodes associated with a second class label from the set of nodes based, at least in part, on the class label associated with each node;
extracting, by the server system, from a teacher ML model, a first subset of teacher node embeddings for the corresponding first subset of nodes and a second subset of teacher node embeddings for the corresponding second subset of nodes based, at least in part, on a set of teacher node embeddings of the set of nodes;
generating, by the server system, a first class representation representing a first class of the first subset of nodes based, at least in part, on an aggregation of the first subset of teacher node embeddings;
generating a second class representation representing a second class of the second subset of nodes based, at least in part, on aggregation of the second subset of teacher node embeddings; and
computing, by the server system, the feature metric based, at least in part, on comparing the first class representation, the second class representation, and a teacher node embedding corresponding to each node.

7. The computer-implemented method as claimed in claim 1, wherein determining the set of positive embedding pairs comprises:
randomly selecting, by the server system, at least one node from the node batch as the reference node;
accessing, by the server system, the set of node features associated with the reference node from the database;
generating, by the server system, a reference node embedding for the reference node based, at least in part, on the set of reference node features; and
identifying, by the server system, a first subset of node embeddings from the set of node embeddings that are related to the reference node embedding based, at least in part, on the class label of each node in the node batch to obtain the set of positive embedding pairs.

8. The computer-implemented method as claimed in claim 7, wherein determining the set of negative embedding pairs comprises:
identifying, by the server system, a second subset of node embeddings from the set of node embeddings that are unrelated to the reference node embedding based, at least in part, on the class label of each node in the node batch to obtain the set of negative embedding pairs.

9. The computer-implemented method as claimed in claim 1, further comprising:
accessing, by the server system, an entity-related dataset from the database, the entity-related dataset comprising information related to a plurality of entities;
generating, by the server system, the set of features corresponding to each entity of the plurality of entities based, at least in part, on the information related to the plurality of entities; and
generating, by the server system, the graph based, at least in part, on the set of features for each entity, wherein each particular node of the graph corresponds to each particular entity of the plurality of entities.

10. The computer-implemented method as claimed in claim 1, further comprising:
accessing, by the server system, a training graph from the database, wherein the training graph comprises a set of training nodes comprising a set of training labeled nodes and a set of training unlabeled nodes connected through a set of training edges, wherein each training node in the set of training nodes is associated with a set of training node features and a training positional encoding and each training labeled node in the set of training labeled nodes is associated with a predefined label;
initializing, by the server system, a teacher ML model based, at least in part, on one or more teacher model parameters; and
training, by the server system, the teacher ML model based, at least in part, on performing, for the set of training nodes, iteratively until a teacher predefined criterion is met, a second set of operations comprising:
generating, by the teacher ML model, a set of teacher node embeddings based, at least in part, on the corresponding set of training node features and a corresponding training positional encoding of each training node;
determining, by the teacher ML model, a set of attention scores based, at least in part, on the set of teacher node embeddings;
generating, by the teacher ML model, a teacher probability score for each training unlabeled node in the set of training labeled nodes based, at least in part, on the set of teacher node embeddings;
generating, by the teacher ML model, a teacher node class prediction for each training unlabeled node based, at least in part, on the teacher probability score, the teacher node class prediction comprising the hard label prediction;
computing, by a cross-entropy loss function, a teacher cross-entropy loss for each training unlabeled node based, at least in part, on the teacher node class prediction and a ground truth label associated with the corresponding unlabeled node; and
optimizing the one or more teacher model parameters based, at least in part, on the teacher cross-entropy loss.

11. The computer-implemented method as claimed in claim 1, further comprising:
accessing, by the server system, the graph from the database, wherein the graph comprises the set of nodes comprising a set of labeled nodes and a set of unlabeled nodes connected through a set of edges, wherein each node is associated with the set of node features and a positional encoding and each labeled node is associated with the predefined label;
determining, by a teacher ML model associated with the server system, the attention score for each node based, at least in part, on the corresponding set of node features and the corresponding positional encoding of each node; and
generating, by the teacher ML model, the hard label prediction for each unlabeled node in the set of unlabeled nodes based, at least in part, on the corresponding set of node features and the attention score.

12. The computer-implemented method as claimed in claim 1, further comprising:
receiving, by the server system, a prediction request related to the downstream task for an entity associated with an individual node from the set of nodes; and
generating, by the trained student ML model associated with the server system, a task-specific prediction corresponding to the downstream task for the individual node based, at least in part, on a corresponding plurality of node features of the individual node.

13. A server system, comprising:
a communication interface;
a memory comprising executable instructions; and
a processor communicably coupled to the communication interface and the memory, the processor configured to cause the server system to at least:
access for each node of a set of nodes in a graph, a set of node features, a class label, and an attention score from a database associated with the server system, the class label comprising one of a predefined label and a hard label prediction, the attention score indicating an importance of each node with respect to a reference node in the graph;
determine a difficulty metric for each node based, at least in part, on the corresponding set of node features and the corresponding class label;
generate a sequence of node batches for training a student ML model based, at least in part, on the difficulty metric of each node, each node batch comprising a subset of nodes from the set of nodes in a predefined difficulty metric range associated with each node batch;
initialize a student ML model based, at least in part, on one or more student model parameters; and
train the student ML model based, at least in part, on a first set of operations that is performed iteratively until a predefined criterion is met, wherein the first set of operations comprise:
select a node batch from the sequence of node batches;
generate, by the student ML model, a set of node embeddings for the subset of nodes based, at least in part, on the set of node features of each node in the selected node batch;
determine, by the student ML model, a set of positive embedding pairs and a set of negative embedding pairs from the set of node embeddings based, at least in part, on the attention score of each node in the subset of nodes;
compute one or more losses comprising at least an attention-aided contrastive loss, wherein the attention-aided contrastive loss is computed by an attention-aided contrastive loss function based, at least in part, on the set of positive embedding pairs and the set of negative embedding pairs; and
optimize the one or more student model parameters based, at least in part, on the one or more losses,
wherein for a subsequent iteration, a subsequent node batch is selected from the sequence of node batches.

14. The server system as claimed in claim 13, wherein to compute the one or more losses comprising at least a cross-entropy loss, the server system is further caused, at least in part, to:
generate, by the student ML model, a set of probability scores for the subset of nodes based, at least in part, on the corresponding set of node embeddings;
generate, by the student ML model, a node class prediction for each node in the subset of nodes based, at least in part, on the set of probability scores, the node class prediction comprising a student-hard label prediction; and
compute, by a cross-entropy loss function, the cross-entropy loss for each node based, at least in part, on the node class prediction and a ground truth label associated with the corresponding node.

15. The server system as claimed in claim 13, wherein to compute the one or more losses comprising at least a Kullback-Leibler (KL) divergence loss, the server system is further caused, at least in part, to:
generate, by the student ML model, a probability score for each node in the subset of nodes based, at least in part, on the corresponding set of node embeddings;
extract, from a teacher ML model associated with the server system, a teacher probability score associated with the hard label prediction; and
compute, by a KL divergence loss function, the KL divergence loss for each node based, at least in part, on the probability score and the teacher probability score of the corresponding node.

16. The server system as claimed in claim 13, wherein to determine the difficulty metric for each node, the server system is further caused, at least in part, to:
determine a label metric for each node based, at least in part, on the corresponding class label;
determine a feature metric for each node based, at least in part, on the corresponding set of node features; and
compute the difficulty metric based, at least in part on the label metric and the feature metric.

17. The server system as claimed in claim 13, wherein the server system is further caused, at least in part, to:
access a training graph from the database, wherein the training graph comprises a set of training nodes comprising a set of training labeled nodes and a set of training unlabeled nodes connected through a set of training edges, wherein each training node in the set of training nodes is associated with a set of training node features and a training positional encoding and each training labeled node in the set of training labeled nodes is associated with a predefined label;
initialize a teacher ML model based, at least in part, on one or more teacher model parameters; and
train the teacher ML model based, at least in part, for the set of training nodes, iteratively until a teacher predefined criterion is met, a second set of operations comprising:
generate, by the teacher ML model, a set of teacher node embeddings based, at least in part, on the corresponding set of training node features and a corresponding training positional encoding of each training node;
determine, by the teacher ML model, a set of attention scores based, at least in part, on the set of teacher node embeddings;
generate, by the teacher ML model, a teacher probability score for each training unlabeled node in the set of training labeled nodes based, at least in part, on the set of teacher node embeddings;
generate, by the teacher ML model, a teacher node class prediction for each training unlabeled node based, at least in part, on the teacher probability score, the teacher node class prediction comprising the hard label prediction;
compute, by a cross-entropy loss function, a teacher cross-entropy loss for each training unlabeled node based, at least in part, on the teacher node class prediction and a ground truth label associated with the corresponding unlabeled node; and
optimize the one or more teacher model parameters based, at least in part, on the teacher cross-entropy loss.

18. The server system as claimed in claim 13, wherein, the server system is further caused, at least in part, to:
access the graph from the database, wherein the graph comprises the set of nodes comprising a set of labeled nodes and a set of unlabeled nodes connected through a set of edges, wherein each node is associated with the set of node features and a positional encoding, and each labeled node is associated with the predefined label;
determine, by a teacher ML model associated with the server system, the attention score for each node based, at least in part, on the corresponding set of node features and the corresponding positional encoding of each node; and
generate, by the teacher ML model, the hard label prediction for each unlabeled node in the set of unlabeled nodes based, at least in part, on the corresponding set of node features and the attention score

19. The server system as claimed in claim 13, wherein the server system is further caused, at least in part, to:
receive a prediction request related to the downstream task for an entity associated with an individual node from the set of nodes; and
generate, by the trained student ML model associated with the server system, a task-specific prediction corresponding to the downstream task for the individual node based, at least in part, on a corresponding plurality of node features of the individual node.

20. A non-transitory computer-readable storage medium comprising computer-executable instructions that, when executed by at least a processor of a server system, cause the server system to perform a method comprising:
accessing for each node of a set of nodes in a graph, a set of node features, a class label, and an attention score from a database associated with the server system, the class label comprising one of a predefined label and a hard label prediction, the attention score indicating an importance of each node with respect to a reference node in the graph;
determining a difficulty metric for each node based, at least in part, on the corresponding set of node features and the corresponding class label;
generating a sequence of node batches for training the student ML model based, at least in part, on the difficulty metric of each node, each node batch comprising a subset of nodes from the set of nodes in a predefined difficulty metric range associated with each node batch;
initializing the student ML model based, at least in part, on one or more student model parameters; and
training the student ML model based, at least in part, on performing a first set of operations iteratively until a predefined criterion is met, the first set of operations comprising:
selecting a node batch from the sequence of node batches;
generating, by the student ML model, a set of node embeddings for the subset of nodes based, at least in part, on the set of node features of each node in the selected node batch;
determining, by the student ML model, a set of positive embedding pairs and a set of negative embedding pairs from the set of node embeddings based, at least in part, on the attention score of each node in the subset of nodes;
computing one or more losses comprising at least an attention-aided contrastive loss, wherein the attention-aided contrastive loss is computed by an attention-aided contrastive loss function based, at least in part, on the set of positive embedding pairs and the set of negative embedding pairs; and
optimizing the one or more student model parameters based, at least in part, on the attention-aided contrastive loss,
wherein for a subsequent iteration, a subsequent node batch is selected from the sequence of node batches.
